(19) United States
(12) Patent Application Publication
(10) Pub. No.: US 2024/0403365 A1
(43) Pub. Date: Dec. 5, 2024

(54) CONFIGURING A LOAD CONTROL SYSTEM USING TEMPLATE DATABASES

(71) Applicant: Lutron Technology Company LLC, Coopersburg, PA (US)

(72) Inventors: Arya Abraham, Bethlehem, PA (US); Agniva Banerjee, Easton, PA (US); Brian A. Jay, Chesterbrook, PA (US); Christopher M. Jones, Downingtown, PA (US)

(73) Assignee: Lutron Technology Company LLC, Coopersburg, PA (US)

(21) Appl. No.: 18/680,855

(22) Filed: May 31, 2024

Related U.S. Application Data
(60) Provisional application No. 63/470,152, filed on May 31, 2023.
(60) Provisional application No. 63/526,848, filed on Jul. 14, 2023.

(51) Int. Cl. G06F 16/901

(52) U.S. Cl. CPC G06F 16/901

(57) ABSTRACT

Systems, methods, and apparatus are described herein for enabling configuration and/or control of a load control system based on templates for different area types. Programming information may be stored in a template database. Each template database may include one or more devices or device types defined for the area type. Programming information may be generated for being included in the template database for configuring the one or more devices or device types. The template database may be transmitted to each of a plurality of local processor devices in the load control system. The template database may include a template identifier for each device or device type therein. Each local processor device may use the template identifier to map the programming information in the template database to physical devices in the load control system that are managed by the local processor device. Each local processor device may create a local instance database that corresponds to a template database configured for an area type in a load control system.

### CROSS-REFERENCE TO RELATED APPLICATIONS

This application claims priority to U.S. Provisional Application No. 63/470,152, filed May 31, 2023, and U.S. Provisional Application No. 63/526,848, filed Jul. 14, 2023, each of which is incorporated by reference herein in its entirety.

### BACKGROUND

A user environment, such as a residence, an office building, or a hotel for example, may be configured using various types of load control systems. A lighting control system may be used to control the lighting loads in the user environment. A motorized window treatment control system may be used to control the natural light provided to the user environment. A heating, ventilation, and air-conditioning (HVAC) system may be used to control the temperature in the user environment. Each load control system may include various control devices.

### SUMMARY

Systems, methods, and apparatus are described herein for enabling configuration and/or control of a load control system based on templates for different area types. As described herein, a template database (e.g., a different template database) may be created for different area types in a load control system. Each template database may include one or more devices or device types defined for the area type. Programming information may be generated for being included in the template database for configuring the control of one or more devices or device types. The programming information may corresponding to each device or device type. The programming information may include at least one of control settings, association information, scene settings, or load control levels. The template database may be transmitted to each of a plurality of local processor devices in the load control system.

The template database may include a template identifier for each device or device type therein. The template identifier may be used to identify devices and/or device types in the template database. Each local processor device may use the template identifier to map the programming information in the template database to physical devices in the load control system that are managed by the local processor device.

Each local processor device may create a local instance database that corresponds to a template database configured for an area type in a load control system. The instance database may include unique identifiers of physical devices in the load control system that are mapped to template identifiers in the local instance database. Each of the physical devices may be programmed with programming information identified in the template database for the mapped template identifier. The physical devices in the load control system may be controlled according to the programming information.

Updates may be made to the system configuration data stored in the template database. The updates may be transmitted to each of the local processor devices for updating the programming information. The updates may be transmitted to each of the local processor devices in parallel or in response to individual requests from the local processor devices.

### BRIEF DESCRIPTION OF THE DRAWINGS

FIGS. 1A and 1B depict a load control system configured for controlling one or more representative environments, wherein each representative environment is configured for controlling one or more electrical loads.

FIG. 2A is a diagram illustrating a procedure for commissioning and configuring areas of load control system by programming instance databases on local processor devices using a given template database.

FIG. 2B includes a sequence diagram that illustrates a procedure for programming local processor devices and/or other devices without the use of a template database.

FIG. 2C includes a sequence diagram that illustrates a procedure for programming local processor devices and/or other devices with the use of a template and/or a template database.

FIGS. 3A and 3B are flowcharts of examples of procedures for commissioning and configuring areas of load control system using a template database and an instance database.

FIG. 4 is a flowchart of an example of a procedure for updating the system configuration data used to configure and/or control devices in a load control system.

FIGS. 5A-5D depict an example graphical user interface for enabling configuration of different template databases corresponding to area types of a load control system.

FIG. 6 is a block diagram illustrating an example computing device.

FIG. 7 is a block diagram illustrating an example load control device.

### DETAILED DESCRIPTION

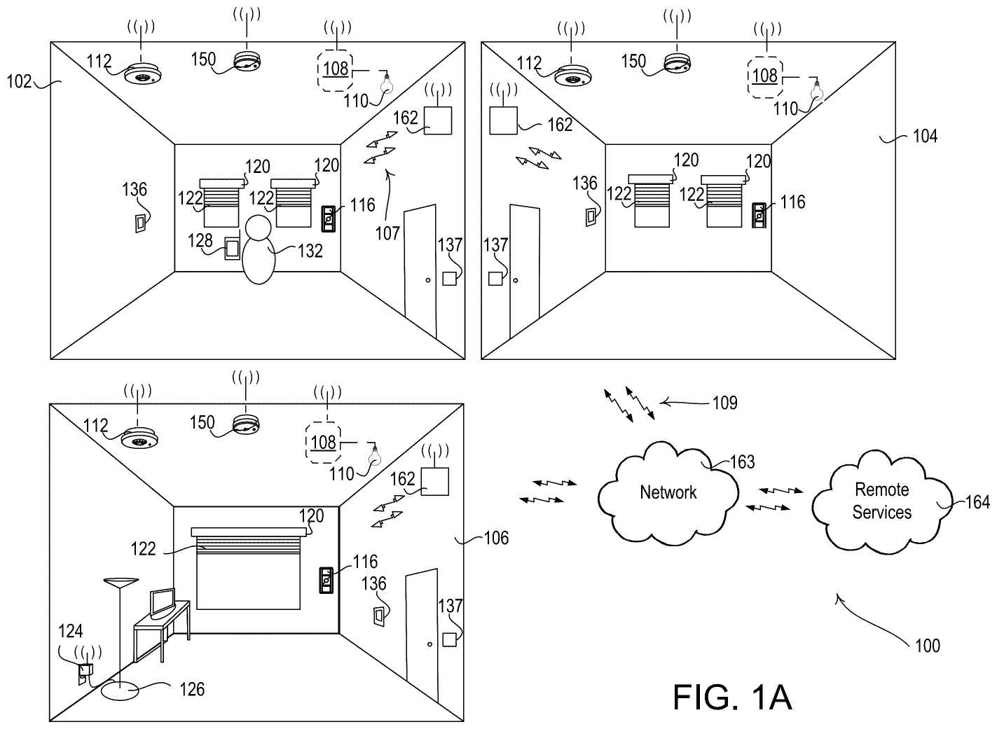

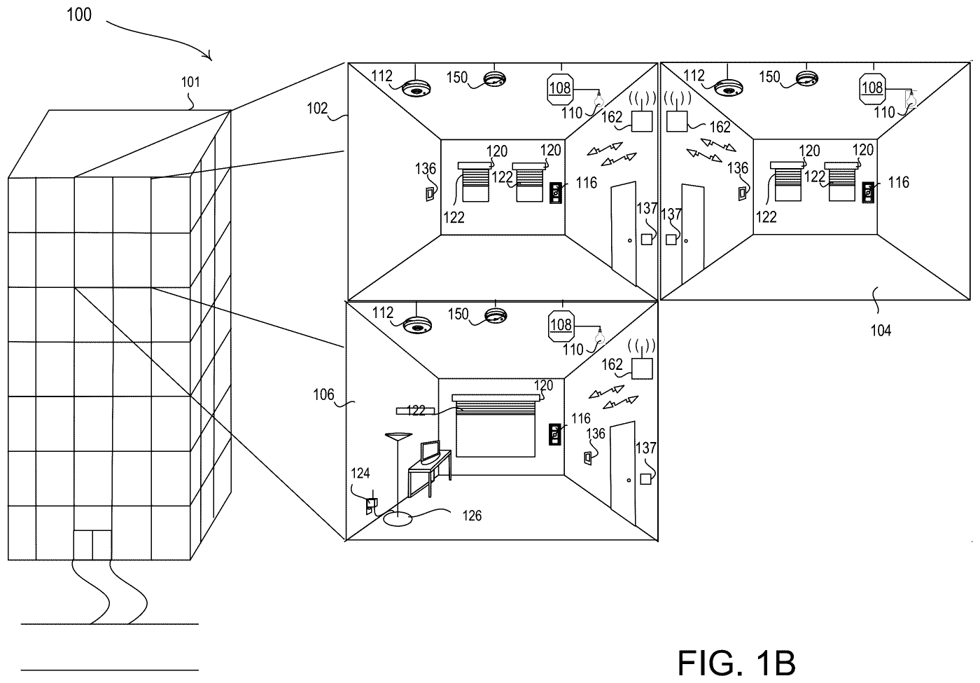

FIG. 1A depicts a load control system 100 configured for controlling electrical loads in one or more areas of a representative environment. As shown in FIG. 1A, rooms 102, 104, and 106 of a building may include representative areas or area types that may be installed with one or more load control devices for controlling the electrical loads. In one example, the rooms 102, 104, 106 may be hotel rooms, offices, rooms in a home, or other rooms in a residential or commercial building. Each load control device in the rooms 102, 104, 106 may be configured to control (e.g., directly control) the amount of power provided to an electrical load and may be controlled by an input device. Example load control devices may include lighting control devices 108 for controlling the amount of power provided to lighting loads 110. The lighting control devices 108 may be configured to control a respective lighting load 110, which may be installed in a lighting fixture. For example, the lighting control devices 108 may comprise light-emitting diode (LED) drivers and the lighting loads 110 may comprise LED light sources. Though described as an LED driver, the lighting control devices 108 may be a dimmer, an electronic switch, a ballast, or another type of lighting control device configured to control one or more lighting loads 110. The lighting control devices 108 may be configured to directly control an amount of power provided to the respective lighting loads 110. The lighting control devices 108 may be configured to receive (e.g., via wired or wireless communications) messages via wireless signals, such as radio-frequency (RF) signals 107, 109, and to control the respective lighting load 110 in response to the received messages. One will recognize that lighting control devices 108 and corresponding lighting loads 110 may be integral and thus part of the same fixture or bulb, for example, or may be separate.

As described herein, a lighting control device, such as the lighting control devices 108 may control a lighting load (e.g., or a plurality of lighting loads), such as the respective lighting loads 110, where the lighting load may include a plurality of multi-colored light emitting diodes (LEDs). In other words, the lighting loads 110 may include within a single package, for example, a number of differently-colored emission LEDs and may be configured such that the chromaticity output of the LEDs is mixed to produce light having varying chromaticity coordinates (e.g., color points) within a color gamut formed by the various LEDs that make up the lighting load. As one example, the lighting loads 110 may each include one or more red LEDs, one or more green LEDs, one or more blue LEDs, and one or more white LEDs (e.g., which may be collectively referred to herein as an RGBW lighting load). White LEDs may comprise substantially white LEDs (e.g., such as yellow and/or mint green LED(s)). Although the RGBW lighting load is described herein with a combination of four LEDs of certain colors, other combinations of LEDs (e.g., more or less LEDs and/or different color LEDs) may be used.

The lighting control devices 108 may each adjust various settings of the corresponding lighting load 110 to adjust the light emitted from the lighting load 110. For example, the lighting control device 108 may adjust the lighting intensity level (e.g., brightness), the color (e.g., correlated color temperature (CCT) value or full color value), value of a vibrancy parameter affecting color saturation, etc. Further, the lighting control devices 108 may each adjust the settings of lighting load(s) over time (e.g., which may be referred to as natural show or natural lighting). For example, the lighting control devices 108 may adjust the settings of the respective lighting loads 110 over time to emulate a sunrise and/or sunset, which may be based on the local time of sunrise and/or sunset for the load control system 100.

Each lighting control device 108 and respective lighting load 110 may be configured to produce white or near-white light of varying intensity levels (e.g., brightness levels) within a range of CCTs ranging from “warm white” (e.g., roughly 2600 Kelvin (K)-3700 K), to “neutral white” (e.g., 3700 K-5000 K) to “cool white” (e.g., 5000 K-8300 K). For example, the lighting control devices 108 and respective lighting load 110 may be configured to produce light of varying chromaticity coordinates that lie along the black body locus or curve. As a further example, such a lighting control device 108 and its respective lighting load 110 may be further configured to produce any of a plurality of colors of varying intensity levels within the color gamut formed by the various LEDs that make up the lighting load 110.

With regard to other load control devices in the load control system 100, the load control system 100 may comprise one or more daylight control devices, such as one or more motorized window treatments 120 in each room 102, 104, 106. The motorized window treatments 120 may comprise motorized cellular shades, for controlling the amount of daylight entering the corresponding room 102, 104, or 106. Each motorized window treatment 120 may comprise a window treatment fabric 122 hanging from a headrail in front of a respective window. Each motorized window treatment 120 may further comprise a motor drive unit (not shown) located inside of the headrail for raising and lowering the window treatment fabric 122 for controlling the amount of daylight entering the corresponding room 102, 104, or 106. The motor drive units of the motorized window treatments 120 may be configured to receive messages via the RF signals 107, 109 and adjust the position of the respective window treatment fabric 122 in response to the received messages. The motor drive units of the motorized window treatments 120 may also or alternatively be configured to receive messages via a wired communication link, and adjust the position of the respective window treatment fabric 122 in response to the received messages. The motorized window treatments may be battery-powered or powered by an alternating-current (AC) or direct-current (DC) power source. The load control system 100 may comprise other types of daylight control devices, such as, for example, a roller shade, a drapery, a Roman shade, a Venetian blind, a Persian blind, a pleated blind, a tensioned roller shade system, an electrochromic or smart window, and/or other suitable daylight control device.

The load control devices in the load control system 100 may comprise a plug-in load control device 124 for controlling a plug-in electrical load. The plug-in electrical load may comprise a plug-in lighting load, such as a floor lamp 126 or a table lamp. The plug-in electrical load may comprise an appliance (e.g., such as a television or a computer monitor). The floor lamp 126 may be plugged into the plug-in load control device 124 for receiving power and/or enabling control. The plug-in load control device 124 may be plugged into a standard electrical outlet and thus may be coupled in series between the AC power source and the plug-in lighting load. The plug-in load control device 124 may be configured to receive messages via the RF signals 107, 109 and to turn on and off or adjust the intensity, color, vibrancy, etc. of the floor lamp 126 in response to the received messages.

The load control devices in the load control system 100 may comprise one or more temperature control devices, such as a thermostat 136, for controlling a temperature in corresponding rooms 102, 104, and 106. The thermostats 136 may each be coupled to a heating, ventilation, and air conditioning (HVAC) system(s) (not shown) via a control link. The control link may be an analog control link or a wired digital communication link. The thermostats 136 may each be configured to communicate messages via a wired and/or wireless communication link with a controller of the HVAC system(s). The thermostat 136 may comprise a temperature sensor for measuring the room temperature of the corresponding rooms 102, 104, and 106 and may control the HVAC system(s) to adjust the temperature in the corresponding rooms 102, 104, and 106 to a setpoint temperature. The load control system 100 may comprise one or more wireless temperature sensors (not shown) located in the corresponding rooms 102, 104, and 106 for measuring the room temperatures. The HVAC system(s) may be configured to turn a compressor on and off for cooling the corresponding rooms 102, 104, and 106 and to turn a heating source on and off for heating the corresponding rooms 102, 104, and 106 in response to the control signals received from the thermostat 136. The HVAC system(s) may be configured to turn a fan of the HVAC system on and off in response to the control signals received from the thermostat 136. The thermostat 136 and/or the HVAC system(s) may be configured to control one or more controllable dampers to control the air flow in the corresponding rooms 102, 104, and 106. The thermostat 136 may be configured to receive messages via the RF signals 107, 109 or wired communication signals and adjust heating, ventilation, and cooling in response to the received messages.

The load control system 100 may comprise one or more other types of load control devices, such as, for example, a screw-in luminaire including a dimmer circuit and an incandescent or halogen lamp; a screw-in luminaire including a ballast and a compact fluorescent lamp; a screw-in luminaire including an LED driver and an LED light source; an electronic switch, controllable circuit breaker, or other switching device for turning an appliance on and off; a motor control unit for controlling a motor load, such as a ceiling fan or an exhaust fan; a drive unit for controlling a motorized window treatment or a projection screen; motorized interior or exterior shutters; an air conditioner; a compressor; an electric baseboard heater controller; a controllable damper; a variable air volume controller; a fresh air intake controller; a ventilation controller; hydraulic valves for use radiators and radiant heating system; a humidity control unit; a humidifier; a dehumidifier; a water heater; a boiler controller; a pool pump; a refrigerator; a freezer; a television or computer monitor; a video camera; an amplifier; an elevator; a power supply; a generator; an electric charger, such as an electric vehicle charger; an alternative energy controller; and/or another type of load control device.

The load control system 100 may comprise one or more input devices configured to receive an input event for controlling one or more load control devices in the load control system 100. The input devices and the load control devices may be collectively referred to as control devices in the load control system 100. The input devices in the load control system 100 may comprise one or more remote control devices, such as remote control devices 116. The remote control devices 116 may each be battery-powered. The remote control devices 116 may each be configured to transmit messages via the RF signals 107 to one or more other devices in the load control system 100 in response to an input event, such as an actuation of one or more buttons or a rotation of a rotary knob of the remote control device 116. For example, the remote control devices 116 may each comprise a keypad. In another example, the remote control devices 116 may each comprise a rotary knob configured to transmit messages via the RF signals 107 to one or more other devices in response to a rotation on the rotary knob (e.g., rotation of a predefined distance or for a predefined period of time). The remote control devices 116 may be mounted to a structure, such as a wall, a toggle actuator of a mechanical switch, or a pedestal to be located on a horizontal surface. In another example, the remote control devices 116 may each be handheld. The remote control devices 116 may each provide feedback (e.g., visual feedback) to a user of the remote control device 116 on a visual indicator, such as a status indicator. The status indicator may be illuminated by one or more light emitting diodes (LEDs) for providing feedback. The status indicator may provide different types of feedback. The feedback may include feedback indicating actuations by a user or other user interface event, a status of electrical loads being controlled by the remote control device 116, and/or a status of the load control devices being controlled by the remote control device 116. The feedback may be displayed in response to user interface event and/or in response to messages received that indicate the status of load control devices and/or electrical loads.

The input devices of the load control system 100 may comprise one or more sensor devices, such as occupancy sensor devices 112 and/or daylight sensor devices 150. The sensor devices may be configured to transmit messages via the RF signals 107 to one or more other devices in the load control system 100 in response to an input event, such as a sensor measurement event. The sensor devices may also or alternatively be configured to transmit messages via a wired communication link to one or more other devices in the load control system 100 in response to an input event, such as a sensor measurement event. The daylight sensor devices 150 may each operate as an ambient light sensor or a daylight sensor and may be configured to perform a sensor measurement event by measuring a total light intensity in the corresponding rooms 102, 104, 106. The daylight sensor devices 150 may each transmit messages including the measured light level or control instructions in response to the measured light level via the RF signals 107.

The occupancy sensor devices 112 may each operate as an occupancy sensor configured to detect occupancy and vacancy conditions in each of the corresponding rooms 102, 104, 106. The occupancy sensor devices 112 may be configured to perform the sensor measurement event by measuring an occupancy condition or a vacancy condition in response to occupancy or vacancy, respectively, of the corresponding room 102, 104, or 106 by a respective user 132. For example, the occupancy sensor devices 112 may each comprise an infrared (IR) sensor configured to detect the occupancy condition or the vacancy condition in response to the presence or absence, respectively, of the user 132. The occupancy sensor devices 112 may each transmit messages including the occupancy conditions and/or vacancy conditions, or control instructions generated in response to the occupancy and/or vacancy conditions, via the RF signals 107. Again, the occupancy sensor devices 112 may also or alternatively transmit messages including the occupancy conditions or vacancy conditions, or control instructions generated in response to the occupancy and/or vacancy conditions via a wired communication link. Lighting control devices may turn on/off or raise/lower lighting intensity levels of lighting loads in response to occupancy and/or vacancy conditions. Motorized window treatments may raise and/or lower a covering material in response to occupancy and/or vacancy conditions.

The input devices in the rooms 102, 104, 106 may include an access point device 137. The access point device 137 may be activated by an access key, such as a keycard or another type of access key. When the access key comes within a certain distance, a signal of the access key is received by the access point device 137 at a certain signal strength, or a signal of the access point device 137 is received by the access key at a certain signal strength, the access point device 137 may receive a unique identifier of the access key and determine that the access key includes the proper unique identifier to open the door to the respective room 102, 104, 106. In an example, the access key and the access point device 137 may utilize RFID or NFC signals to detect the signal strength of the devices. Each activation of the access point device 137 may be tracked in system configuration data that may include the configuration/control for the load control system 100, as further described herein. Activation of the access point device 137 may indicate that the respective room 102, 104, 106 is occupied. The load control devices in the load control system 100 may be automatically controlled to preconfigured states in response to the activation of the access point device 137.

The load control system 100 may comprise other types of input devices, such as, for example, wall controls that are RF based and are hardwired to control electrical loads (e.g., lighting loads, motorized window treatments, etc.), visible light sensors, temperature sensors, humidity sensors, radiometers, cloudy-day sensors, shadow sensors, pressure sensors, smoke detectors, carbon monoxide detectors, air-quality sensors, motion sensors, security sensors, proximity sensors, fixture sensors, partition sensors, multi-zone control units, slider control units, kinetic or solar-powered remote controls, key fobs, cell phones, smart phones, tablets, personal digital assistants, personal computers, laptops, timeclocks, audio-visual controls, safety devices, power monitoring devices (e.g., such as power meters, energy meters, utility submeters, utility rate meters, etc.), central control transmitters, residential controllers, commercial controllers, industrial controllers, and/or another type of input device.

The input devices and the load control devices may be configured to communicate messages between one another on a communication link within the load control system. For example, the input devices and the load control devices may be configured to communicate messages directly to one another via the RF signals 107. The RF signals 107 may be transmitted using a proprietary RF protocol, such as the CLEAR CONNECT protocol (e.g., CLEAR CONNECT TYPE A and/or CLEAR CONNECT TYPE X protocols). Alternatively, the RF signals 107 may be transmitted using a different RF protocol, such as, a standard protocol, for example, one of WIFI, cellular (e.g., 3G, 4G LTE, 5G NR, or other cellular protocol), BLUETOOTH, BLUETOOTH LOW ENERGY (BLE), ZIGBEE, Z-WAVE, THREAD, KNX-RF, MATTER, ENOCEAN RADIO protocols, or a different proprietary protocol. In an example, the input devices may transmit messages to the load control devices via the RF signals 107 that comprise input events (e.g., button presses, sensor measurement events, or other input event) or control instructions (e.g., commands) generated in response to the input events for performing control of the electrical loads controlled by the load control devices. Though communication links may be described as a wireless communication links, wired communication links may similarly be implemented for enabling communications herein.

For devices in the load control system 100 to recognize messages directed to the device and/or to which to be responsive, the devices may be associated with one another by performing an association procedure. For example, for a load control device to be responsive to messages from an input device, the input device may first be associated with the load control device. The association procedure may be performed as a part of one or more commissioning procedures for commissioning the load control system 100 for operation. As one example of an association procedure, devices may be put in an association mode for sharing a unique identifier for being associated with and/or stored at other devices in the load control system 100. For example, an input device and a load control device may be put in an association mode by the user 132 actuating a button on the input device and/or the load control device. The actuation of the button on the input device and/or the load control device may place the input device and/or the load control device in the association mode for being associated with one another. In the association mode, the input device may transmit an association message(s) to the load control device (e.g., directly or through one or more other devices as described herein). The association message from the input device may include a unique identifier of the input device. The load control device may locally store the unique identifier of the input device in association information, such that the load control device may be configured to recognize messages (e.g., subsequent messages) from the input device that may include control instructions (e.g., commands). The association information stored at the load control device may include the unique identifiers of the devices with which the load control device is associated. The load control device may be configured to respond to the messages from the associated input device by controlling a corresponding electrical load according to the control instructions received in the messages. The input device may also store the unique identifier of the load control device with which it is being associated in association information stored locally thereon. A similar association procedure may be performed between other devices in the load control system 100 to enable each device to perform communication of messages with associated devices. This is merely one example of how devices may communicate and be associated with one another and other examples are possible.

According to another example, one or more devices may receive system configuration data (e.g., or subsequent updates to the system configuration data) that is uploaded to the devices and that specifies the association information comprising the unique identifiers of the devices for being associated. The system configuration data may comprise a load control dataset that defines the devices and operational settings of the load control system 100. The system configuration data may include information about the devices in one or more of the rooms 102, 104, 106 and/or the load control system 100. The system configuration data may include association information that indicates defined associations between devices in the load control system. The association information may be updated using any of the association procedures described herein.

One or more intermediary devices may maintain the system configuration data that includes the unique identifiers that make up the associations of devices and/or the configuration of devices in the load control system 100. For example, the input devices and the load control devices may communicate on a communication link in the load control system 100 through one or more intermediary devices. The association information that is maintained in the system configuration data may comprise the unique identifiers of the devices that are associated with one another in each room 102, 104, 106 for identifying and/or enabling communication of messages between devices in the load control system 100. For example, each intermediary device may identify the unique identifiers being transmitted in association messages between devices during the association procedure and store the unique identifiers of the devices as an association in the association information.

The load control system 100 may include one or more local processor devices 162, which may operate as intermediary devices. For example, each local processor device 162 may operate as a central processing device for one or more other devices in one or more rooms 102, 104, 106 in the load control system 100. As shown in FIG. 1A, each room 102, 104, 106 may include a separate local processor device 162 that stores the system configuration data for the input devices and the load control devices in the respective room 102, 104, 106. In some examples, one or more of the local processor devices 162 may be configured with the system configuration data for the input devices and the load control devices in multiple rooms. Each local processor device 162 may be a part of an individual subsystem of devices in the load control system that may be configured and/or controlled by the local processor device 162 in the respective room 102, 104, 106. Each local processor device 162 may be operable to communicate messages to and from the control devices (e.g., the input devices and the load control devices) using the system configuration data stored thereon. For example, the local processor device 162 in room 102 may use system configuration data stored thereon to control the load control devices in room 102; local processor device 162 in room 104 may use system configuration data stored thereon to control the load control devices in room 104; and local processor device 162 in room 106 may use system configuration data stored thereon to control the load control devices in room 106. Each of the local processor devices 162 may be configured to receive messages from the input devices in the respective room 102, 104, 106 and transmit messages to the load control devices in the respective room 102, 104, 106 in response to the messages received from the input devices. Each local processor device 162 may include system configuration data for one or more input devices and load control devices for one or more rooms, such as rooms 102, 104, 106. Each local processor device 162 may route the messages based on the association information stored in the system configuration data stored thereon. The input devices, the load control devices, and the local processor devices 162 may be configured to transmit and receive messages via the RF signals 107 and/or via a wired communication link.

Each of the local processor devices 162 may receive information in messages from devices in the load control system 100 in the respective room 102, 104, 106 (e.g., inputs from the input devices in the respective room 102, 104, 106) via the RF signals 107 or wired communication signals and generate corresponding control instructions for performing control at one or more of the load control devices in the respective room 102, 104, 106. For example, the local processor devices 162 may receive an indication of a button press from the remote control device 116 in the respective room 102, 104, 106 or an indication of a sensor measurement from a sensor device (e.g., such as the occupancy sensor 112 and/or the daylight sensor 150 in the respective room 102, 104, 106) and interpret these messages to generate control instructions (e.g., for controlling the load control devices in the respective room 102, 104, 106) based on control settings defined in the system configuration data of the load control system 100. For example, the remote control device 116 in room 102 may transmit a message that indicates an actuation of a button on the remote control device 116 to the local processor device 162 in room 102, which may receive the message indicating the actuation and identify the button that was actuated to generate corresponding control instructions based on the control settings defined in the system configuration data stored at the local processor device 162 in room 102. The local processor device 162 in room 102 may then transmit messages to one or more of the load control devices in room 102 for the load control devices in room 102 to then control respective electrical loads in room 102. In another example, the local processor device 162 in room 102 may forward the inputs received from the input devices in room 102 to the load control devices in room 102. Thus, the input devices or the load control devices themselves may interpret the inputs to generate the control instructions, and the local processor devices 162 may each route the messages comprising the inputs based on the association information stored thereon. According to another example, the input devices in room 102 may directly communicate with the load control devices in room 102 without the assistance of the local processor devices 162 in room 102. The local processor devices 162 may still monitor such communications.

According to a further example, the local processor devices 162 may each originate and then communicate messages with input devices and/or load control devices in the respective rooms 102, 104, 106. Such communications by the local processor devices 162 may include system configuration data (e.g., including control settings) for the control devices, such as configuring scene buttons or presets on light switches. A preset may be a predefined scene or a control configuration setting (e.g., load control level, such as level of a motorized window treatment, temperature level, lighting level, etc.) for controlling one or more devices in an area. Each area (e.g., each of the rooms 102, 104, 106) defined in the system configuration data may have its own presets, which may be downloaded to store locally in the respective local processor device 162. Communications from the local processor devices 162 may also include, for example, messages that are directed to load control devices and include control instructions (e.g., commands) for causing the load control devices to control respective electrical loads in response to the received messages. For example, the local processor devices 162 may communicate messages to adjust lighting intensity levels, to adjust lighting color, to adjust positions of the window fabric 122, to adjust a setpoint temperature via the HVAC system, etc. Thus, the local processor devices 162 may operate as a control device or input device itself, by generating the control instructions thereon in response to one or more triggering events (e.g., timeclock events and/or other local triggering events) to send messages including control instructions to the load control devices to control the corresponding electrical loads in the load control system 100. The local processor devices 162 may also, or alternatively, send a message to a load control device that causes the load control device to operate locally-stored settings or control instructions.

The load control system 100 of FIG. 1A may be configured such that the local processor devices 162 are each configured to communicate with a user device 128. The user device 128 may be a computing device executing software for enabling configuration and/or control of the devices in the load control system 100. The user device 128 may be used within a close vicinity to a local processor device 162, such that the user device 128 and the local processor device 162 may directly communicate in a point-to-point fashion (e.g., using a short-range wireless communication protocol, such as BLUETOOTH, BLUETOOTH LOW ENERGY, or other suitable protocol) and/or via a local network 163 (e.g., using a standard wired or wireless network communication protocol, such as Internet protocol, Ethernet-based protocols, WI-FI protocols, or other suitable network protocols). For example, the local network 163 may be provided by one or more routers that are located close to one or more of the rooms 102, 104, 106. It may be advantageous to allow the user 132 to interact with the local processor devices 162 via the user device 128 and to control the control devices in the respective room 102, 104, 106 of the load control system 100 from remote locations, such as via the local network 163 or other public or private network. Similarly, it may be advantageous to allow third-party integrators to communicate with the local processor devices 162 in order to control the control devices in the respective rooms 102, 104, 106 and/or provide services to occupants of the rooms 102, 104, 106. Different occupants or users may be assigned a user identifier or user type for communicating with different local processor devices 162. For example, a user may be assigned a user identifier or user type for communicating with one or more of the local processor devices 162 that is configured to control the load control devices in the respective room 102, 104, 106 to which the user has been checked in, in the case of a hotel or residence for example.

The local processor devices 162 may be configured to communicate with the user device 128 via the local network 163. The user device 128 may be a personal computing device, such as a laptop, a smart phone, and/or a tablet device. The user device 128 may be characterized by a unique identifier (e.g., a serial number or address stored in memory) that uniquely identifies the user device 128 and thus the occupant 132. As another example, the user device 128 may be configured to transmit messages to the local processor devices 162, for example, in one or more messages transmitted via Internet Protocol packets and/or another wireless communication protocol. The user device 128 may be configured to transmit messages over the local network 163 to an external service, and then the messages may be received by local processor devices 162. The user device 128 may transmit and receive RF signals 109. The RF signals 109 may be the same wireless frequency and/or transmitted using the same protocol as the RF signals 107. Alternatively, or additionally, the user device 128 may be configured to transmit RF signals according to another signal type and/or protocol. The load control system 100 may comprise other types of computing devices coupled to the local network 163, such as a desktop personal computer (PC), a wireless-communication-capable television, or any other suitable Internet-Protocol-enabled device. Examples of load control systems operable to communicate with mobile and/or computing devices on a network are described in greater detail in commonly-assigned U.S. Patent Application Publication No. 2013/0030589, published Jan. 31, 2013, entitled LOAD CONTROL DEVICE HAVING INTERNET CONNECTIVITY, the entire disclosure of which is hereby incorporated by reference.

The load control system 100 may be responsive to remote services 164 that may be provided on one or more remote computing devices, such as one or more cloud servers or other remote servers with which the local processor devices 162 and/or the user device 128 may be configured to communicate via the network 163. For example, the remote server operating the remote services 164 may communicate with local processor devices 162 and/or the user device 128 via the local network 163 and the RF signals 109. The RF signals 109 may be communicated on a different communication link than the RF signals 107. For example, the user device 128 may communicate with the local processor devices 162 and/or the control devices may communicate with the user device 128 and/or the local processor devices 162 using RF signals 107 that may be configured on a first wireless communication link (e.g., configured using a first wireless spectrum and/or protocol, such as BLUETOOTH, BLUETOOTH LOW ENERGY (BLE), ZIGBEE, Z-WAVE, THREAD, KNX-RF, MATTER, ENOCEAN RADIO protocols, or a proprietary protocol, such as CLEAR CONNECT OR CLEAR CONNECT X), while the local processor devices 162 and/or the user device 128 may communicate, via the network 163, with the remote computing devices on which the remote services 164 are provided using a second wireless communication link (e.g., configured using a first wireless spectrum and/or protocol, such as WIFI, cellular, and/or another wireless communication protocol).

The remote services 164 may include or have access to one or more portions of the system configuration data generated by users of the remote services 164 and stored in the remote server(s) from which the remote services 164 are offered. For example, one or more portions of the system configuration data may be generated at the user device 128 or the local processor devices 162 and may be transmitted to the remote server on which the remote services 164 are operating for enabling configuration and/or control of the load control system 100. Additionally, or alternatively, one or more portions of the system configuration data may be generated by users of the remote services 164 and stored in the remote server(s) from which the remote services 164 are offered and may be transmitted to the local processor devices 162 and/or the user device 128 for performing configuration and/or control of the load control system 100. The remote services 164 may be located on a remote server that is located remotely or locally with respect to the building in which the rooms 102, 104, 106 are located. The remote services 164 may be operated by a server or may be serverless.

The operation of the load control system 100 may be programmed and configured using, for example, the user device 128 or other computing device (e.g., when the user device is a personal computing device). The user device 128 may provide the user with access to a configuration/control application (e.g., via a graphical user interface (GUI)) for allowing a user 132 to program how the load control system 100 will operate and/or be controlled. For example, the configuration/control application may be executed as a local application on the user device 128, or as a remote application or service (e.g., executing via the remote services 164 on the remote server, the local processor devices 162, and/or another remote computing device) that is accessed via a local application (e.g., a web browser or other local application enabling a web interface). The configuration/control application and/or the local processor devices 162 (e.g., via instructions from the configuration/control application) may generate and/or store the system configuration data for enabling control of the devices in the load control system 100. The system configuration data may be stored in one or more system configuration databases (e.g., programming databases) that define the operation of the load control system 100.

Portions of the system configuration data may be pre-defined using design software that may be executed to design one or more portions of the system configuration database (e.g., a programming database) that may define how the load control system 100 may operate once installed. For example, the design software may be executed on remote server(s) from which the remote services 164 may be accessed, or the design software may be executed by another computing device, and the system configuration data defined by the design software may be uploaded to the remote server(s) for being accessed via the remote services 164. The design software may be implemented to define in the system configuration data (e.g., in the system configuration database) one or more areas (e.g., virtual areas) of the building or other environment in which the load control system 100 may be installed. In addition, the design software may be implemented to define in the system configuration data a number of devices and device types for being installed in each of the areas in the system configuration data. For example, the design software may identify a number of devices and device types in a floorplan (e.g., a virtual floorplan) configured to simulate the design of the load control system after being installed in the areas of a building. The devices to be installed in the load control system 100 may be identified by configuration identifiers (e.g., virtual identifiers). The system configuration data may include a unique name of each of the areas and/or a corresponding area type (e.g., king standard room, queen standard room, king deluxe room, queen deluxe room, king suite room, queen suite room, a conference room, a lobby, or another type of room) in which the devices are to be installed. The configuration identifiers may be stored in the system configuration data with association information and/or programming information that identifies the operational characteristics of the devices to be installed with a predefined device type in a corresponding area of the load control system 100. For example, the programming information may include the control settings, scene settings, load control levels (e.g., dimming levels, levels of a motorized window treatment, temperature levels, etc.), and/or other programming information for enabling configuration and/or control of the devices to be installed in the load control system 100. After the installation of the devices in the load control system 100, the association information of the configuration identifiers of each of the devices in the system configuration data may loaded with a unique identifier (e.g., a serial number, address, or other unique identifier) of that particular device in the load control system 100.

After the installation of the devices in the load control system 100, the installed devices may be powered on and activated during an activation procedure (e.g., a commissioning procedure) for enabling operation of the installed devices in the physical space. The activation procedure may include discovery of devices in a given area and selection of the discovered devices for operation in that area. An activation procedure may be implemented for activating the devices that have been installed in separate areas (e.g., each of the rooms 102, 104, 106 and/or other areas) of a building to enable separate control of the devices in each of areas. For example, the devices that have been installed in the room 102 may be activated by discovering the unique identifiers of the devices that have been installed in the room 102 and storing the unique identifiers as activated devices at the local processor device 162 for the room 102 to enable operation of the activated devices in the load control system 100. The devices that have been installed in rooms 104, 106 may each be separately activated by discovering the unique identifiers of the devices that have been installed in the respective rooms 104, 106 and storing the unique identifiers as activated devices at the respective local processor devices 162 for each of the rooms 104, 106.

The devices that have been installed in the load control system 100 may be discovered by triggering transmission of a discovery message at each device being discovered. For example, the discovery message may be transmitted in response to an actuation of a button on the device itself. In another example, the discovery message may be triggered in response to receipt of a discovery request message that is received from another device. The discovery request message may be transmitted by the user device 128, one of the local processor devices 162, and/or another device in the load control system 100. The discovery message that is transmitted by each device may include the unique identifier of the device being discovered. The discovery message may be transmitted via the RF signals 107 or 109. The discovery message may be received at the user device 128, one of the local processor devices 162, and/or another device in the load control system 100 for being stored thereon.

One or more of the discovered devices may be stored as an activated device for operation in a given area being controlled by a respective one of the local processor devices 162. For example, the user device 128 may receive the discovery messages transmitted by each of the installed devices, or the user device 128 may receive the unique identifiers of the devices discovered from one of the local processor devices 162. The user 132 may actuate a button on the user device 128 to send a feedback message that causes a discovered device to perform feedback to identify the device. The feedback may allow the user 132 to identify whether the discovered device is installed in the area being configured for operation. The feedback may be performed by changing a state of an electrical load and/or a light source capable of being controlled by the device. For example, the lighting control device 108 may change an on/off state or a color of the lighting load 110. The motorized window treatment 120 may adjust a position of the window treatment fabric 122. Each of the devices in the load control system 100 may have one or more light sources (e.g., LEDs) installed thereon that may be controlled to change an on/off state or color of the light source(s) to provide feedback to the user 132. The user 132 may identify the device that is providing the feedback and select the device on the graphical user interface of the user device 128 to select the device for being activated for operation in a given area. The user device 128 may also, or alternatively, discover devices based on a signal strength threshold of RF signals 107, 109 that are transmitted by and/or received at the user device 128. For example, the user device 128 may select the devices for activation in an area based on the signal strength threshold of the RF signals 107, 109 received from each device. The signal strength threshold may be a received signal strength indicator (RSSI) threshold or another threshold. The user device 128 may store the unique identifiers of the selected devices for operation in a given area and communicate the unique identifiers to the local processor device 162 for activating the devices in the area.

The activated devices may be configured and/or controlled according to the pre-defined programming information in the system configuration data. For example, programming information for each of the activated devices may be sent to the local processor device 162 for the area and/or the device itself for configuring the devices for operation.

The user device 128 may be used to update the system configuration data on which the load control system 100 operates. For example, the user 132 may request the system configuration data, or portions thereof, via the configuration/control application executing on the user device 128 for being displayed on the user device 128. The configuration/control application may request the system configuration data from one or more other devices in the load control system 100, such as the local processor devices 162 and/or the remote server on which the remote services 164 are operating. Upon receiving the information requests from the configuration/control application on the user device 128, the local processor devices 162 and/or the remote services may respond by communicating the requested system configuration data to the user device 128. The configuration/control application executing on the user device 128 may also allow the user device 128 to communicate messages to the local processor devices 162 and/or the remote services 164 to modify, edit, or change the system configuration data, such as a scene configuration stored therein, as further described herein. In one example, the system configuration data may include scene buttons, sensor inputs, or other presets as input for triggering control of one or more load control devices according to a given scene.

As shown in FIG. 1B, the load control system 100 may be installed in a building 101, such as a hotel building, an office building, a condo building, or another commercial or residential building or environment. As further shown in FIGS. 1A and 1B, one or more rooms in the building 101 may have a similar design and/or configuration, as illustrated by rooms 102 and 104. For example, the room 102 and the room 104 may include the same number of devices (e.g., input devices and/or load control devices) and/or devices of the same type (e.g., remote control device 116, motorized window treatment 120, thermostat 136, occupancy sensor 112, daylight sensor 150, lighting control device 108, access point 137, local processor device 162, etc.). One or more rooms in the building 101 may have a different design and/or configuration, as illustrated by rooms 102 and 106. For example, the room 106 may include a different number of devices (e.g., input devices and/or load control devices) and/or devices of a different type than the room 102. As shown in FIGS. 1A and 1B, the room 106 includes a single motorized window treatment 120 and an additional plug-in control device 124 for controlling the floor lamp 126. In one example of a commercial hotel building, the rooms 102, 104, 106 may be of one or more types selected from king standard room, queen standard room, king deluxe room, queen deluxe room, king suite room, queen suite room, a conference room, a lobby, or another type of room. In a residential building, such as a condo building or a home residence, the rooms 102, 104, 106 may be of one or more types selected from different unit types, such as apartment or condo types having different configurations. For example, rooms 102 and 104 in FIGS. 1A and 1B may be king standard rooms, and room 106 may be a king deluxe room.

The devices to be installed in the building 101 may be designed in advance and the configuration of the rooms and other areas in the system configuration data for controlling devices in the building 101 may be pre-configured for being uploaded to the devices in the load control system 100. In another example, the user 132 may be required to walk around to each of the rooms and/or other areas in the building 101 to generate and/or update the system configuration data using the user device 128. As several of the rooms in the building 101 may have the same or similar configuration (e.g., number of devices and/or types of devices), the configuration and/or control of the system configuration data may require multiple portions of the system configuration data (e.g., or database in which the system configuration data may be stored) to be similarly configured. As the system configuration data may be generated and/or stored in a single location or dataset (e.g., single database stored at one or more remote servers), the system configuration data may be generated and/or updated by a single user at a time, which may cause delay in the commissioning and/or configuration of the load control system 100.

To assist in the configuration of the load control system 100, the user 132 may generate one or more templates that may be used to generate the system configuration data for rooms or other areas in the building 101 having the same or similar configuration (e.g., number of devices and/or types of devices). The information stored in a template may be stored in a template database or other dataset. For example, one or more template databases may be created and stored in the system configuration data for each area type (e.g., room type or other area type) in the load control system. For example, an area may include a room, a portion of a room, or another area of the building, and the area type may be identified by a room type or another type of area in a building. The template databases may be generated with a number of devices for the area type to be stored in the system configuration data. The template databases may be generated with the system configuration data (e.g., control setting, scene settings, load control levels, etc.) for configuring and/or controlling the devices to be installed in the area type for the given template database. The template databases may be stored in one or more databases or other datasets at a remote computing device (e.g., the remote computing device providing remote services 164) for being accessed by each of the local processor devices 162 of the load control system 100 during commissioning or other configuration of the devices in each of the areas of the building 101.

After the template databases have been created and stored for room types or other area types in one or more representative environments, the local processor devices 162 in each of the respective rooms 102, 104, and 106 may receive the template database of the area type of the respective rooms 102, 104, and 106. For example, the local processor device 162 in each of rooms 102 and 106 may receive the template database having an area type of king standard type while the local processor device 162 in room 104 may receive the template database having an area type of king deluxe type. After receiving the template database, each of the local processor devices 162 may configure the load control system and create room-specific information. The local processor devices 162 may each store the room specific information locally.

The local processor devices 162 may each update the information stored in the template database and/or receive information in different template databases for being locally stored thereon. For example, the local processor devices 162 may each update the information in the template database with a new configuration, such as the room type, one or more control devices, and/or one or more electrical loads in the room. The local processor devices 162 may each backup the new configuration to the remote service 164 via the local network 163. Meanwhile, the local processor devices 162 may each receive the new template database from the remote service 164 via the local network 163.

The user 132 may access one of the local processor devices 162 via the user device 128. The local processor device 162 that is being accessed may retrieve the template databases that are available from the remote services 164 and provide the templates to the user device 128. The user may select a template database for the corresponding room type that the user 132 is configuring for being controlled by the local processor device 162. The selection of the template database may allow the local processor device 162 (e.g., in response to the selection on the user device 128) to create a local instance of the template database by receiving the selected template database from the remote services 164 and storing the local instance thereon. The local instance of the template database may be stored as a local instance database or other dataset on the local processor device 162. Though the local instance database or template database may be described herein as a database, it is clear that the data being configured and/or stored therein may be stored in another form or dataset.

The local instance database may identify a predefined number and/or types of devices for being configured for the area type identified by the template database. For example, the local instance database may identify the number of input devices and/or load control devices for being configured in the room. As shown in FIGS. 1A and 1B, the user 132 may select, via the user device 128, a different local instance database for being generated on the local processor device 162 in room 102 than for being generated on the local processor device 162 in the room 106. Each type of local instance database that is based on the same template database may have a same number and types of devices identified therein. The local processor device 162 may be programmed, via the user device 128, by receiving and storing the unique identifier (e.g., serial number, address, or other unique identifier) for each of the devices installed in the room in the corresponding location of the local instance database for the given device type. After the local instance database stored at the local processor device 162 in the room 102 is programmed, the user 132 may proceed to another room to access another local processor device 162 in the next room to cause the local processor device 162 in the next room to similarly generate and program a local instance database with the unique identifiers of the appropriate devices in the next room. Alternatively, or additionally, a second user device 128 (e.g., being used by another user) may simultaneously access the local processor device 162 in other rooms to cause the local processor device 162 in other rooms to generate and program local instance databases with the unique identifiers of the appropriate devices in other rooms. This may allow for multiple users to commission or otherwise configure the devices in the load control system 100 at the same time.

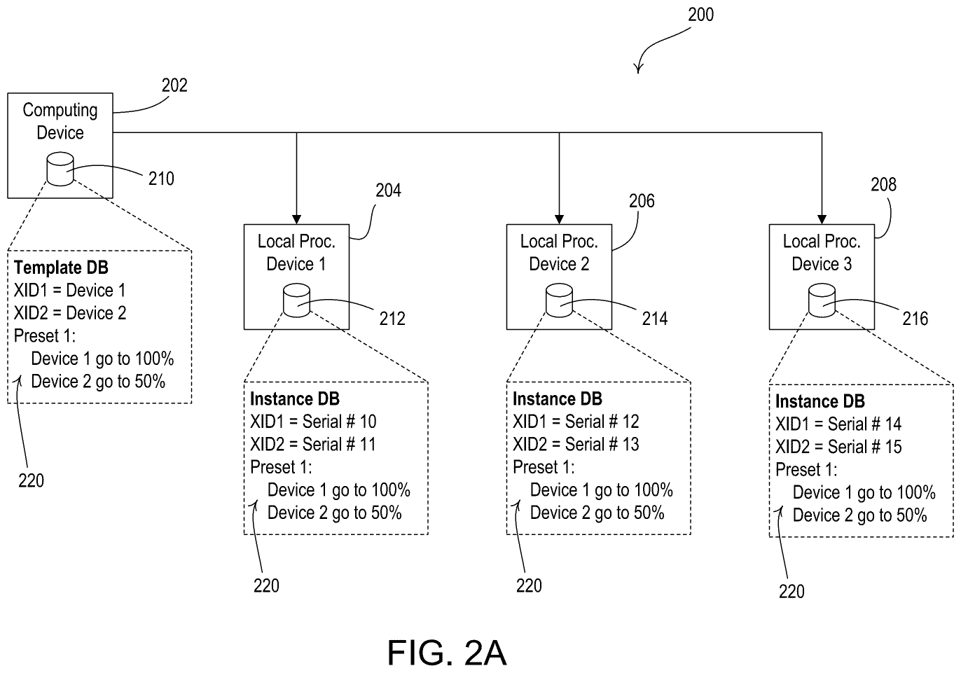

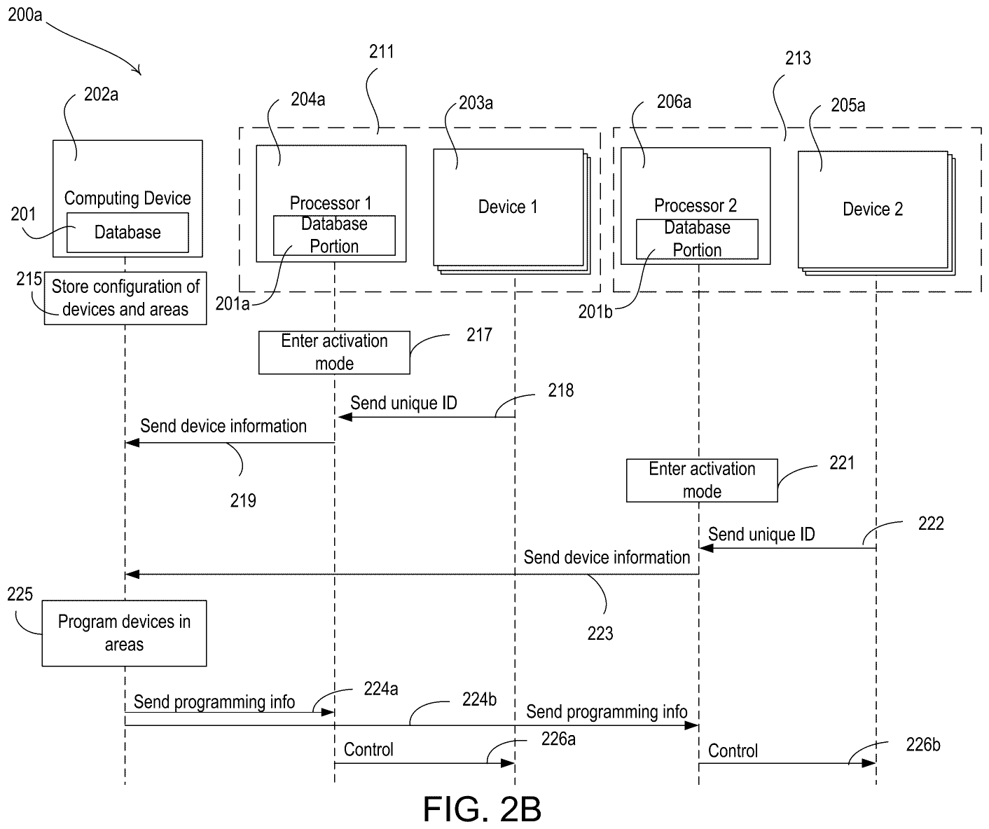

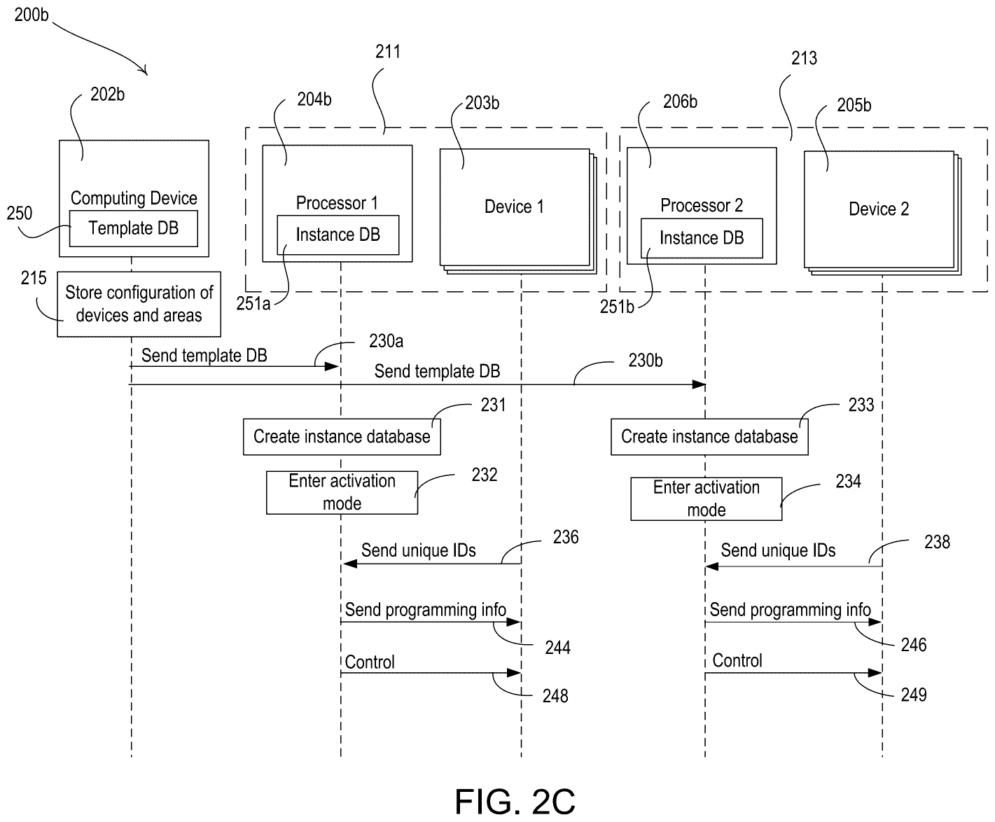

FIG. 2A is a diagram illustrating a system 200 (e.g., the load control system 100) for executing a procedure for commissioning and configuring areas of a load control system by programming local instance databases on local processor devices using a given template database. The system 200 may include a computing device 202, which may store a template database 210. For example, the computing device 202 may be a remote computing device or server on which remote services, such as the remote services 164 shown in FIG. 1A, may be implemented. The computing device 202 may include, or be in communication with, a user device, such as the user device 128 shown in FIGS. 1A and 1B, a desktop personal computer, and/or another computing device, as described herein.

The computing device 202 may store the template database 210, which may be accessed by and/or stored on each of the local processing devices 204, 206, 208 to generate a separate instance database 212, 214, 216 on each of the local processing devices 204, 206, 208. The template database 210 may include a number of template identifiers that are provided as placeholders for being populated with the unique identifiers of devices in each of the instance databases 212, 214, 216 at the local processor devices 204, 206, 208 during commissioning. The template database 210 may include programming information that is stored in each of the instance databases 212, 214, 216 at the local processor devices 204, 206, 208 for allowing control via the instance database after the device identifiers of the devices installed in the load control system are populated in the instance databases 212, 214, 216.

The computing device 202 may create the template database 210 (e.g., in response to inputs from a user). After creating the template database 210, the computing device 202 may assign the template database 210 to an area type (e.g., in response to inputs from a user). An area type may include one or more types of areas, such as a room, a portion of a room, or another type of area in a building. The template database 210 may correspond to a room type (e.g., king standard room, queen standard room, king deluxe room, queen deluxe room, king suite room, queen suite room, a conference room, a lobby, or another type of room) or another area type for which the local processor devices 204, 206, 208 may each be configured. The computing device 202 may configure one or more additional template databases for other area types to be configured in the load control system. For example, the computing device 202 may create a separate template database corresponding to each of one or more room types (e.g., king standard, queen standard, etc.) or other area types in the load control system.

The template database 210 may include a list of devices for the corresponding area type. Each device may be assigned a corresponding device type in the template database 210. The template database 210 may include multiple devices having the same and/or different device types. Each device in the template database 210 may include a template identifier (e.g., an XID) that is assigned to the device in the template database 210. The template identifier of each device may be populated (e.g., subsequently populated after installation of the device) with a unique identifier (e.g., serial number, address, or other unique identifier) of the device that is actually installed in the load control system. The template identifier may be (e.g., initially be) populated with a temporary identifier for each device in the template database. The devices may be input devices, load control devices, and/or other devices in the load control system. The device types may include remote control devices, lighting control devices, motorized window treatments, sensor devices, occupancy sensors, daylight sensors, plug-in load control devices, local processor devices, and/or other devices in the load control system. Each device (e.g., each template identifier) may be labeled with a device name for configuring and/or controlling the device that is ultimately assigned to the template identifier in the template database. Each device (e.g., each template identifier) may be labeled with a device name for identifying the device that may later be identified by the unique identifier (e.g., serial number, address, or other unique identifier) of the device that is actually installed in the load control system. For example, the device with the template identifier XID1 may be labeled with a device name (e.g., Device 1) and the device with the template identifier XID2 may be labeled with another device name (e.g., Device 2). The device names that are assigned to a given device may have a corresponding device type for indicating the device type of the device to have its unique identifier populated in the template identifier. For example, the computing device 202 may label (e.g., in response to user input) the device with the template identifier XID1 with a device name that identifies a lighting control device and/or fixture in the ceiling of a room, while labeling the device with the template identifier XID2 with a device name that identifies a wall sconce or a floor lamp. In another example, the computing device 202 may label (e.g., in response to user input) the device with the template identifier XID1 with a device name that identifies a lighting control device and/or fixture in the ceiling of a room, while labeling the device with the template identifier XID2 with a device name that indicates a motorized window treatment. The device types of each template identifier XID1 and XID2 may be the same or different.

The template database 210 may further include programming information for programming the control of each of the devices represented by the template identifiers in the template database. The programming information may include control settings 220 in the system configuration data stored in the template database 210. The control settings 220 may include a type of control for each of the devices identified by the template identifiers in the template database. For example, the control settings 220 may include control settings for controlling each of the devices in response to an input from an input device. As shown in FIG. 2A, the input may be a preset (e.g., a selection of a preset or scene) for enabling control according to a scene that may be triggered by the selection of the preset. The preset may be selected in response to a button press on a remote control device, or another triggering event received from an input device (e.g., an occupancy and/or vacancy condition detected by occupancy sensor, a daylight level detected by daylight sensor, a timing event identified at local processor device, or other triggering event) for triggering the scene configuration identified in the control settings. The control settings may indicate that the device labeled Device 1 is programmed to go to 100% intensity in response to the preset and that the device labeled Device 2 is programmed to go to 50% intensity in response to the preset.

In addition to the control settings, the programming information in the template database 210 may include associations between the template identifiers for associating each of the devices in the load control system for enabling control according to the control settings 220 after the unique identifiers of the devices have been entered into the instance database, such as the local instance database 212, 214, 216 on each of the local processor devices 204, 206, 208. For example, the programming information of the template database 210 may include an association for associating the device having the temporary identifier XID1 and the device having the temporary identifier XID2 for enabling control according to a scene configuration. In such an example, when the device having the temporary identifier XID1 is an input device and the device having the temporary identifier XID2 is a load control device, the device having the temporary identifier XID2 may be responsive to commands transmitted by the device having the temporary identifier XID1.

Instead of the template database 210 actually including the system configuration data itself, such as the control settings 220 and/or the associations between template identifiers in the system configuration data stored in the template database 210, the template database 210 may include a reference to a location at which to find and/or download the system configuration data itself. For example, the template identifiers may be mapped to pointers for accessing the system configuration data at another location. The system configuration data may include programming information that may be accessed via the reference for programming the local processor devices 204, 206, 208. This may allow the template database 210 to be sent to the local processor devices 204, 206, 208 more quickly and utilizing less memory and processing resources.

After creating the template database 210, which may be stored on the computing device 202 for being accessed by local processor devices 204, 206, 208 of the system 200, the computing device 202 may transmit the template database 210 to the local processor devices 204, 206, 208. In response to receiving the template database 210, each local processor device 204, 206, and 208 may create a local instance database 212, 214, 216 that may be programmed using the system configuration data stored in the template database 210 (e.g., the control settings 220), or otherwise accessible via the local instance database 212, 214, 216.

The local processor devices 204, 206, 208 may populate or map the template identifiers (XIDs) corresponding to each device in each local instance database 212, 214, 216 with unique identifiers of each of the installed devices. The unique identifiers for each of the template identifiers in the template database 210 may be sent to each of the local processor devices 204, 206, and 208. For example, the user device and/or the given local processor device 204, 206, 208 may signal the computing device 202 to transmit the unique identifiers to the local processor device 204, 206, 208 for being populated in the template identifiers of each local instance database. In another example, each local processor device 204, 206, 208 may be pre-loaded with the respective local instance database 212, 214, 216 and the template identifiers of each of the local instance database 212, 214, 216 may be pre-populated with the unique identifiers for each of the devices for which a unique identifier is available.

Device specific information may be manually entered into the instance databases 212, 214, 216 or the device specific information may be automatically entered. For example, each of the local processor devices 204, 206, 208 may receive and/or generate an instance of the template database 210 (e.g., the respective local instance database 212, 214, 216) for allowing a user to enter, via the user device, the unique identifiers of the devices, such that the devices may be controlled with the programming information in the template database 210. The user may enter (e.g., via the user device) the device specific information for each of the template identifiers (XIDs) in the template database 210. The device specific information may include the unique identifiers for the actual physical devices installed in the areas of the load control system being controlled by each local processor device 204, 206, and 208.

Each of the local processor devices 204, 206, 208 may receive and enter (e.g., automatically enter) the template identifiers (XIDs) in the template database 210. The user device may implement an activation procedure to discover the unique identifiers of the physical devices in the load control system. During the activation procedure, the user device may discover the local devices and then associate one of the discovered devices (e.g., having a unique identifier) with a virtual device (e.g., having a template identifier) in the local instance database of the present area. During the activation procedure, the user device may obtain the unique identifier of the discovered devices and associate the unique identifiers with a corresponding template identifier in memory at one of the local processor devices 204, 206, and 208. The user device may send the unique identifiers to the local processor devices 204, 206, and 208 for being stored with their corresponding template identifiers (XIDs) in the respective local instance databases 212, 214, 216.

In one example, the template identifier XID1 of the local instance database 212 may be programmed with the unique identifier (e.g., serial number 10) of the one or more load control devices installed in the load control system that are configured with the unique identifier (e.g., serial number 10). The template identifier XID2 of the local instance database 212 may be programmed with the unique identifier (e.g., serial number 11) of the one or more load control devices installed in the load control system that are configured with the unique identifier (e.g., serial number 11). The template identifier XID1 of the local instance database 214 may be programmed with the unique identifier (e.g., serial number 12) of the one or more load control devices installed in the load control system that are configured with the unique identifier (e.g., serial number 12). The template identifier XID2 of the local instance database 214 may be programmed with the unique identifier (e.g., serial number 13) of the one or more load control devices installed in the load control system that are configured with the unique identifier (e.g., serial number 13). The template identifier XID1 of the local instance database 216 may be programmed with the unique identifier (e.g., serial number 14) of the one or more load control devices installed in the load control system that are configured with the unique identifier (e.g., serial number 14). The template identifier XID2 of the local instance database 216 may be programmed with the unique identifier (e.g., serial number 15) of the one or more load control devices installed in the load control system that are configured with the unique identifier (e.g., serial number 15). Input devices may similarly be programmed in each local instance database 212, 214, and 216. The local instance databases 212, 214, and 216 may each be stored locally in the corresponding local processor device 204, 206, and 208 for which the database was generated. As different users may access different local processor devices 204, 206, and 208 at the same time, the template identifiers of the local instance databases of two or more of the local processor devices 204, 206, and 208 may be populated with unique identifiers of devices at the same time.

The programming information (e.g., the control settings 220 and/or the association information) may be included in the template database 210 that is transmitted from the computing device 202 to each local processor device 204, 206, and 208 in each area for programming the devices in the area that is controlled by the local processor device 204, 206, and 208 in each area. For example, the template database 210 itself may be sent to the local processor device 204, 206, and 208 in each room or other area. The local processor device 204, 206, and 208 in each room or other area may request the template database 210 including the programming information for programming each of the devices in each local instance database 212, 214, 216. Additionally, or alternatively, after the local processor device 204, 206, and 208 in each room is powered on and/or given access to the computing device 202 on which the template database 210 is stored, the corresponding local processor device 204, 206, and 208 in each room may request the template database 210 including the programming information for programming the corresponding devices in each local instance database 212, 214, 216. Additionally, or alternatively, transmission of the template database 210 may be requested by the user (e.g., via the user device) based on a user input that causes the computing device 202 to send the template database 210 to the local processor devices 204, 206, and 208. The template database 210 may include the programming information (e.g., control settings 220 and/or association information for associating the unique identifiers of the devices in the template database 210). The template database 210 may be preprogrammed to enable control at each of the rooms or other areas that are controlled by the local processor device 204, 206, and 208 according to the programming information in the system configuration data stored in the template database 210. The local processor device 204, 206, and 208 in each room or other area having the template identifiers associated with the unique identifiers of the physical devices for their respective portions of the load control system may enable each local processor device 204, 206, and 208 in each room or other area to control and/or program devices in the load control system in a similar manner based on the programming information in the system configuration data stored in the respective local instance databases 212, 214, 216 (e.g., as created from the same template database 210).

The system configuration data in the template database 210 may be used as a starting point for configuration that may be edited, such that the local processor device 204, 206, 208 may be preconfigured with local instance databases 212, 214, 216 for a selected area type (e.g., via the user device) for starting a configuration that may be modified. The system configuration data in each local instance databases 212, 214, 216 may be updated after it is downloaded from the computing device 202. For example, the programming information (e.g., the control settings 220 and/or association information) of a given template database (e.g., for an area type) may be updated. The local processor device 204, 206, 208 may update (e.g., via input from the user device) programming information, such as the control settings, association information, and/or other system configuration data downloaded at a local processor devices 204, 206, and 208 in each room or other area.

The use of the template database 210 (e.g., a common template database to create multiple local instance databases) that includes system configuration data (e.g., the programming information therein) from which portions of the load control system may be configured and/or controlled may allow for updates to be made to a configuration of a given area type in one common location (e.g., the template database 210). The local processor devices 204, 206, and 208 in each room or other area may retrieve updates to the programming information for performing updates to their local control from the template database 210 (e.g., the common template database) at the computing device 202. For example, each local processor device 204, 206, and 208 in each room may receive a signal (e.g., timing signal for updates, user input from actuation on local processor device or user device, push of updates from remote computing device 202, and/or another signal) to receive updates to the programming information. The local processor devices 204, 206, and 208 in each room may re-download the programming information stored in the template database 210, or portions thereof that have been updated since the last download of the programming information stored in the template database 210. The template databases may be updated and/or added/removed at the computing device 202 (e.g., via user input) for being accessed by local processor devices 204, 206, and 208. When an updated programming information is being transmitted to the local processor devices 204, 20, 208, the updated portion of the template database may be transmitted instead of the entire template database.

FIGS. 2B and 2C show sequence diagrams that illustrate procedures for programming processor devices and/or other devices installed in an area for which the devices may be configured and/or controlled. FIG. 2B includes a sequence diagram 200a that illustrates an example of a procedure for programming local processor devices and/or other devices without the use of a template database. FIG. 2C includes a sequence diagram 200b that illustrates an example of a procedure for programming local processor devices and/or other devices with the use of a template and/or a template database.

As shown in FIG. 2B, each of the local processor devices 204a, 206a may be installed in separate areas 211, 213. For example, the areas 211, 213 may be rooms or another area in a building. The areas 211, 213 may be of the same area type (e.g., room type or other area type) or different area types. Each of the areas 211, 213 may include one or more other devices 203a, 205a. The devices 203a, 205a may be load control devices, input devices, and/or other devices installed in a given area.

Each of the local processor devices 204a, 206a in each of the areas 211, 213 may be in communication with a computing device 202a. The computing device 202a may include one or more remote computing devices, such as remote server devices, configured to offer remote services and/or system configuration data to the local processor devices 204a, 206a for configuring and/or controlling the load control system. As illustrated in the sequence diagram 200a of FIG. 2B, the computing device 202a may store system configuration data at 215 that defines the configuration of devices and areas (e.g., virtual areas) in the load control system. The system configuration data may be stored in a system configuration database 201. For example, portions of the system configuration data may be configured via design software and may identify a number of devices and device types to be installed for each area 211, 213. The system configuration data may be identified in a floorplan (e.g., a virtual floorplan), a list of areas with corresponding system configuration data for each area, or another configuration in storage in the system configuration database 201. The floorplan or list of areas may include areas (e.g., virtual areas) having a defined area type. The devices to be installed in each area 211, 213 may be identified by configuration identifiers in the system configuration data. The configuration identifiers may each be stored in the system configuration data with association information and/or programming information that identifies the operational characteristics of the physical devices to be installed in each area 211, 213. For example, the association information of the configuration identifiers of each of the devices in the system configuration data may comprise a unique identifier (e.g., a serial number) of that particular device in the load control system (e.g., after installation of the devices of the load control system). In addition, the programming information may include the control settings, scene settings, load control levels (e.g., intensity levels, positions of a motorized window treatment, temperatures, etc.), and/or other programming information for enabling configuration and/or control of the devices to be installed in each area 211, 213.

The devices 203a, 205a in each of the areas 211, 213 may be activated for operation in the load control system. For example, the local processor device 204a may enter an activation mode at 217 for activating the devices 203a for operation in the area 211. During the activation mode, the local processor device 204a may discover the unique identifier of each of the devices 203a and/or store the unique identifiers of the devices 203a as activated devices for the area 211. Each of the devices 203a may transmit their respective unique identifier at 218. Each of the devices 203a may transmit a discovery message at 218 including the unique identifier in response to a triggering event (e.g., an actuation of a button thereon or receipt of a triggering message). The local processor device 206a may enter an activation mode at 221 for activating the devices 205a for operation in the area 213. During the activation mode, the local processor device 206a may discover the devices 205a and/or store the devices 205a as activated devices for the area 213. Each of the devices 205a may transmit respective discovery messages including their respective unique identifier at 222. The discovery message including the unique identifier may be transmitted by each of the devices 205a at 222 in response to a triggering event (e.g., an actuation of a button thereon or receipt of a triggering message).

The discovery and/or activation of the devices 203a, 205a may be performed using a user device, as described herein. As the processor devices 204a, 206a and/or the user device may discover devices in different areas based on receipt of a discovery message comprising the unique identifiers of the respective devices, the user device may be implemented to select the devices for being activated in a given area 211, 213, as described herein. For example, a user may select the devices 203a, 205a to be activated for each area 211, 213 in response to the discovered devices for the area 211, 213 on a graphical user interface of the user device. In another example, the devices 203a, 205a may be discovered for being activated for each area 211, 213 based on a signal strength threshold of RF messages that are transmitted to and/or received from the devices 203a, 205a. The activated devices for each area 211, 213 may be stored at the respective local processor devices 204a, 206a as activated devices for the area 211, 213.

The computing device 202a may operate as a central location for storing device information for activated devices in a given area. Each device in a given area may be activated independently and the device information of the activated devices may be sent to the computing device 202a. The unique identifiers may be stored in the association information at the computing device 202a for being associated with the unique identifier of other activated devices in the load control system. The unique identifier of each activated device may be stored with corresponding predefined programming information in the system configuration database 201.

In an example, device information for each activated device in the area 211 may be transmitted from the respective local processor device 204a for the area 211, as devices send their unique identifiers at 218 in the discovery message. The local processor device 204a may transmit the device information at 219 for an activated device 203a in the area 211. The device information may include the unique identifier and/or a device type of the discovered device 203a. The device information may also include a unique identifier of the local processor device 204a for the area 211. The local processor device 204a may similarly transmit the device information to the computing device 202a as each of the devices 203a are activated. The local processor device 206a may transmit the device information at 223 for an activated device 205a in the area 213. The device information may include the unique identifier and/or a device type of the discovered device 205a. The device information may also include a unique identifier of the local processor device 206a for the area 213. The local processor device 206a may similarly transmit the device information to the computing device 202a as each of the devices 205a are activated. The identifier of each of the areas 211, 213 may include unique identifiers of the area and/or an area type. The unique identifier of the area and/or the area type may be configured by the user of the user device in communication with the local processor devices 204a, 206a.

A user may continue to move around to different areas and/or return to areas of the building to activate one or more additional devices until each of the devices in the load control system are activated. The computing device 202a may continue to receive device information from local processor devices as devices are being activated. The computing device 202a may determine that a device is being activated from a given area. For example, the computing device 202a may receive a message from the local processor device 204a (e.g., before the activation procedure starts at 217, before the device information is sent at 219, or after the device information is sent at 219) that indicates that devices are being activated in the area 211. The computing device 202a may receive a subsequent message from the local processor device 206a (e.g., before the activation procedure starts at 221, before the device information is sent at 223, or after the device information is sent at 223) that indicates that devices are being activated in the area 213. In another example, the computing device 202a may choose which of the devices is being activated at a given time. The computing device 202a may choose the devices being activated based on the information that is received at 219, 223, an indication from the user device based on a selection by the user, or a predefined order of devices to be activated. The computing device 202a may understand, from the selection or indication of the device being activated, the configuration identifier of the device that is presently being activated so that when it receives the unique identifier at 219, 223, the computing device 202a may perform association with the appropriate unique identifiers and/or store the unique identifier with the appropriate programming information in the system configuration database 201.

The device information transmitted at 219 and 223 for each of the areas 211, 213 may be received by the computing device 202a. The computing device 202a may be implemented to program the operation of the devices 203a, 205a in each of the areas 211, 213. For example, the unique identifiers of each of the devices 203a, 205a may be associated with a corresponding configuration identifier (e.g., virtual identifier) having programming information for configuring and/or controlling the operation of each of the devices 203a, 205a in a given area. The identifier of each of the areas 211, 213 may be identified as corresponding to an identifier of an area (e.g., virtual area) that has been stored at the computing device 202a. Each of the areas 211, 213 may be identified as corresponding to an area (e.g., virtual area) stored at the computing device 202a based on a unique identifier of the areas 211, 213 or the corresponding local processor devices 204a, 206a that indicate a location of the areas 211, 213 and/or an area type of each of the areas 211, 213. For example, the area 211 may be identified in the floorplan or list of areas based on a unique identifier indicating the location of the area 211 (e.g., a unique identifier indicating floor number, room number, etc.) that corresponds with a location identified by a configuration identifier in the predefined system configuration data. The area 211 may also, or alternatively, be identified as having an area type that corresponds to an area type defined for one or more areas of the floorplan. The area 213 may similarly be identified in the floorplan or list of areas based on a unique identifier indicating the location of the area 213 (e.g., a unique identifier indicating floor number, room number, etc.) that corresponds with a location identified by a configuration identifier in the predefined system configuration data. The area 213 may also, or alternatively, be identified as having an area type that corresponds to an area type defined for one or more areas in the floorplan. The area type for each of the areas 211, 213 may be the same or different.

The computing device 202a may program the operation of each of the devices 203a and 205a in each of the areas 211, 213 at 225 using the predefined system configuration data. Programming may include generating association information for associating devices 203a, 205a installed in a given area 211, 213 and/or generation of programming information that identifies the operational characteristics of the devices 203a, 205a installed in each of the areas 211, 213. For example, the programming information may include the control settings, scene settings, load control levels (e.g., dimming levels, levels of a motorized window treatment, temperature levels, etc.), and/or other programming information for enabling configuration and/or control of the devices 203a, 205a installed in each of the areas 211, 213.

The programming may be performed at 225 by identifying the association information and/or programming information in the system configuration information that is stored at the computing device 202a that corresponds to a given device in an area defined in the system configuration information. Each of the devices 203a in the area 211 may have a device type that corresponds to a device type in an area of the system configuration data with defined association information and/or programming information for programming the devices 203a. Each of the devices 205a in the area 213 may have a device type that corresponds to a device type in an area of the system configuration information with defined association information and/or programming information for programming the devices 205a.

The programming information for each of the devices 203a in the area 211 may be transmitted to the local processor device 204a at 224a. The local processor device 204a may store the programming information in a local database portion 201a. The programming information for each of the devices 205a in the area 213 may be transmitted to the local processor device 206a at 224b. The local processor device 206a may store the programming information in a local database portion 201b. Each of the local processor devices 204a, 206a may control the devices 203a, 205a in their respective areas 211, 213 based on the received programming information. For example, the local processor device 204a may transmit a message at 226a configured to control one or more devices 203a according to programming information stored in the local database portion 201a (e.g., as received at 224a). The local processor device 206a may transmit a message at 226b configured to control one or more devices 205a according to the programming information stored in the local database portion 201b (e.g., as received at 224b). In another example, the local processor devices 204a, 206a may transmit the programming information to each of the devices 203a, 205a for local storage thereon for enabling operation in each area 211, 213.

As the device information for each activated device is being coordinated at a central location (e.g., the computing device 202a), each device may be individually activated and the device information may have to be sent to the central location (e.g., the computing device 202a) for generating association information and/or programming information for the device. The association information and/or programming information for the devices 203a, 205a in each area 211, 213 may be stored at the central location (e.g., the computing device 202a) such that any updates to the system are to be performed at the central location. As each of the areas 211, 213 may be of a same area type that may have a separate corresponding area (e.g., virtual area in a floorplan) defined in the system configuration data, each update to a given area type may be performed multiple times to update each area defined in the system configuration data. As the system configuration data grows to include programming information for tens, hundreds, or even thousands of areas, the updates to the system configuration data may utilize a larger amount of processing and/or memory resources. As the system information data grows, the number of updates to be performed to a given area type may also increase making the system information data more susceptible to errors in the updating process. The programming information for each of the areas 211, 213 being stored at a central location that is remote from the local processor devices 204a, 206a may prevent the local processor devices 204a, 206a in each of the areas 211 from activating and/or programming the respective devices 203a, 205a in their area in parallel. For example, the activation and/or programming may be coordinated at 225 at a central location (e.g., the computing device 202a) and the programming information may be transmitted to each of the processor devices 204a, 206a. As such, the programming of the devices in each of the areas 211, 213 may need to be performed sequentially and/or after activation of the devices in each of the areas.

FIG. 2C includes the system diagram 200b that illustrates an example of a procedure for programming local processor devices and/or other devices with the use of a template database 250. As shown in FIG. 2C, each of the local processor devices 204b, 206b may be installed in separate areas 211, 213. Each of the areas 211, 213 may include one or more other devices 203b, 205b. The devices 203b, 205b may be load control devices, input devices, and/or other devices installed in a given area.

Each of the local processor devices 204b, 206b in each of the areas 211, 213 may be in communication with a computing device 202b. The computing device 202b may include one or more remote computing devices, such as remote server devices, configured to offer remote services and/or system configuration data (e.g., programming information therein) to the local processor devices 204b, 206b for configuring and/or controlling the load control system. As illustrated in the sequence diagram 200b of FIG. 2C, the computing device 202b may store system configuration data at 215 that defines the configuration of devices and areas (e.g., virtual areas) in the load control system. The computing device 202b may create a template database 250 for each of the areas defined for the load control system. Different template databases 250 may be created for different area types defined for the areas in the system configuration data. One or more template identifiers may be identified in each template database 250 that are predefined for each area having a corresponding area type in the system configuration data. The device type of each of the devices may be added to each template database 250 along with association information and/or programming information that has been predefined in the system configuration data for each of the devices. The programming information may include the control settings, scene settings, load control levels, and/or other programming information for enabling configuration and/or control of the devices installed in the load control system.

During creation of the template databases, a unique template identifier (XID) may be generated for each device or device type identified in the template database for a given area type. Each template identifier may be labeled with a device name for a device that is ultimately assigned to the template identifier to be installed and/or activated in the load control system. The template identifiers may each be labeled with a device name for an input device or one or more load control devices to be installed and/or activated in the load control system.

The template database 250, or information stored therein, may be sent to a local processor device 204b at 230a. For example, the template database 250, or one or more portions of the system configuration data stored therein, may be transmitted at 230a to the local processor device 204b that is installed for a particular area type. The template database 250, or one or more portions of the system configuration data, may be transmitted at a scheduled time or after the template database for the area type is updated. In another example, the template database 250, or one or more portions of the system configuration data stored therein, may be transmitted at 230a to the local processor device 204b in response to a request from the local processor device 204b or the user device that is accessing the local processor device 204b for performing configuration. The request may include an area type for the area 211, or the area type may be indicated by the unique identifier of the local processor device 204b.

The template database 250, or information stored therein, may be sent to a local processor device 206b at 230b. For example, the template database 250, or one or more portions of the system configuration data stored therein, may be transmitted at 230b to the local processor device 206b that is installed for a particular area type. The template database 250, or one or more portions of the system configuration data, may be transmitted at a scheduled time or after the template database 250 for the area type is updated. In another example, the template database 250, or one or more portions of the system configuration data stored therein, may be transmitted at 230b to the local processor device 206b in response to a request from the local processor device 206b or the user device that is accessing the local processor device 206b for performing configuration. The request may include an area type for the area 213, or the area type may be indicated by the unique identifier of the local processor device 206b. The area type for the areas 211, 213 may be the same are type or a different area type.

Each of the local processor devices 204b, 206b may create and store an instance database 251a, 251b locally that reflects the number of devices and/or types of devices in the template database 250 for the area types of the respective areas 211, 213. For example, the local processor device 204a may create and store an instance database 251a at 231. The local processor device 204b may create and store an instance database 251b at 233. Initially, each of the local processor devices 204b, 206b may generate the instance database 251a, 251b locally for storing in template identifiers unique identifiers of local devices that have been installed and/or for being activated in respective areas 211, 213. The unique identifiers of installed devices in the area 211 may be entered (e.g., automatically or manually via the user device) and then stored in the corresponding template identifiers in the instance database 251a. The unique identifiers of installed devices in the area 213 may be entered (e.g., automatically or manually via the user device) and then stored in corresponding template identifiers in the instance database 251b. The unique identifiers in each of the instance databases 251a, 251b may be associated (e.g., when the corresponding template identifiers are associated in the programming information) to associate control devices (e.g., input devices and load control devices) for enabling control in the respective areas 211, 213 (e.g., based on the programming information received from the template database 250). Similar types of devices in a similar area type (e.g., king suite, queen suite, conference room, master bedroom, etc.) may be similarly associated in the instance databases 251a, 251b using the template database 250 (e.g., based on the programming information).

The instance databases 251a, 251b may include the devices and/or device types for each of the devices 203b, 205b to be installed and/or activated for operation in the load control system. For example, the local processor devices 204b, 206b may each enter an activation mode at 232, 234 for activating devices in respective areas 211, 213. The activation procedures may be performed at each of the local processor devices 204b, 206b in parallel, or at overlapping or separate times. For example, different users may implement the activation procedures at the local processor devices 204b, 206b for activating and/or programming devices in respective areas 211, 213 in parallel. The local processor devices 204b, 206b may discover the devices 203b, 205b and/or activate the discovered devices 203b, 205b for operation in respective areas 211, 213, as described herein.

During the activation mode, the local processor device 204b may discover the unique identifier of each of the devices 203b and/or store the unique identifiers of the devices 203b in the template identifiers of the local instance database for the area 211. Each of the devices 203b may transmit their respective unique identifier at 236. Each of the devices 203b may transmit a discovery message at 236 including the unique identifier in response to a triggering event (e.g., an actuation of a button thereon or receipt of a triggering message). During the activation mode, the local processor device 206b may discover the devices 205b and/or store unique identifiers of the devices 205b in the template identifiers of the local instance database for the area 213. Each of the devices 205b may transmit respective discovery messages including their respective unique identifier at 238. The discovery message including the unique identifier may be transmitted by each of the devices 205b at 238 in response to a triggering event (e.g., an actuation of a button thereon or receipt of a triggering message).

The discovery and/or activation of the devices 203b, 205b may be performed using a user device, as described herein. As the processor devices 204b, 206b and/or the user device may discover devices in different areas based on receipt of a discovery message comprising the unique identifiers of the respective devices, the user device may be implemented to select the devices for being activated in a given area 211, 213, as described herein. For example, a user may select the devices 203b, 205b to be activated for each area 211, 213 in response to the discovered devices for the area 211, 213 on a graphical user interface of the user device. In another example, the devices 203b, 205b may be discovered for being activated for each area 211, 213 based on a signal strength threshold of RF messages that are transmitted to and/or received from the devices 203b, 205b. The activated devices for each area 211, 213 may be stored at the respective local processor devices 204b, 206b as activated devices for the area 211, 213. Each of the local processor devices 204b, 206b may discover and/or activate the devices 203b, 205b installed in respective areas 211, 213 in parallel, or in overlapping or sequential times.

The local processor devices 204b, 206b may transmit programming information to the devices in respective areas 211, 213 based on the programming information in the instance databases 251a, 251b that are based on the template database 250 for the area types of the respective areas 211, 213. The local processor device 204b, 206b may be automatically transmit the programming information in response to population of the unique identifiers in the corresponding template identifiers in the instance databases 251a, 251b. For example, the local processor device 204b may transmit to one of the devices 203b that has the unique identifier that is populated in a corresponding template identifier the programming information in the local instance database 251a for the template identifier. The local processor device 206b may transmit to one of the devices 205b that has the unique identifier that is populated in a corresponding template identifier the programming information in the local instance database 251b that applies to the device having the unique identifier stored in the template identifier. In some examples, the local processor devices 204b, 206b may transmit the programming information to the devices 203b, 205b in the respective areas 211, 213. However, in some examples, such as where the processor devices 204b, 206b may operate as an intermediary device for enabling control of load control devices in the load control system, the programming and/or association information may not be sent to the devices 203b, 205b.

Each of the local processor devices 204b, 206b may control the devices 203b, 205b in their respective areas 211, 213 based on the programming information. For example, the local processor device 204b may transmit a message at 248 configured to control one or more devices 203b in the area 211 according to the programming information configured based on the local instance database 251a. The local processor device 206b may transmit a message at 249 configured to control one or more devices 205b in the area 213 according to the programming information configured based on the local instance database 251b. In another example, the local processor devices 204b, 206b may transmit the programming information to each of the devices 203b, 205b for enabling operation in each area 211, 213.

The transfer of the programming information to local instance databases 251a, 251b using the template database 250, as depicted in FIG. 2C, may allow for more efficient processing, transmission, and/or storage of the programming information for the load control system. For example, the programming information may be stored and/or updated for each area type (e.g., where each area 211, 213 is the same or similar area type), instead of for each specific area 211, 213 (e.g., where each area 211, 213 is the same or similar area type) as defined for the load control system. A single update may be made to a template database defined for an area type and that update may be propagated to each of the portions of the load control system installed in an area having a similar area type. The use of the template databases may allow for multiple local processor devices 204b, 206b to be activated and/or perform programming of the devices 203b, 205b in their respective areas 211, 213 in parallel. The programming information can be changed for a particular area type (e.g., for a particular template database 250) and the programming information may be transferred to each local processor device 204b, 206b that uses the template database 250 (e.g., for the particular area type) for programming the respective devices 203b, 205b in the areas 211, 213. Different users may access the local processor devices 204b, 206b at the same time and access the local instance databases 251a, 251b stored thereon for programming the devices 203b, 205b installed in the respective areas 211, 213 for operation.

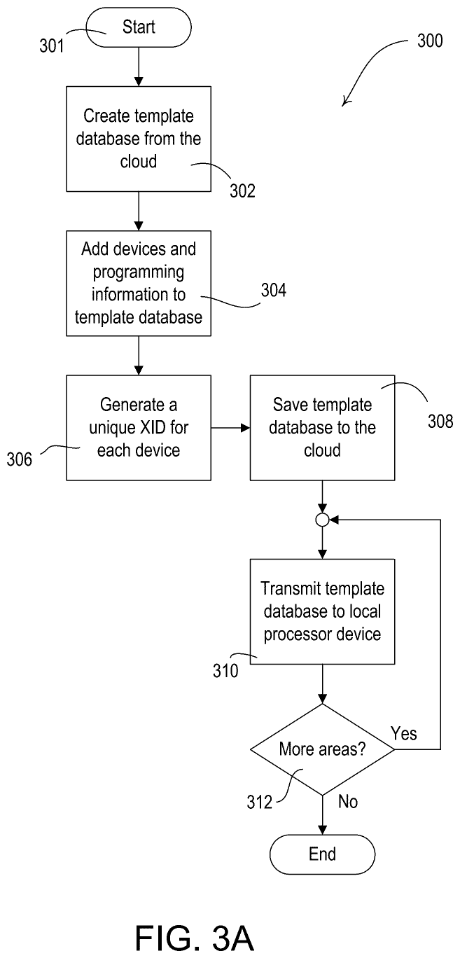

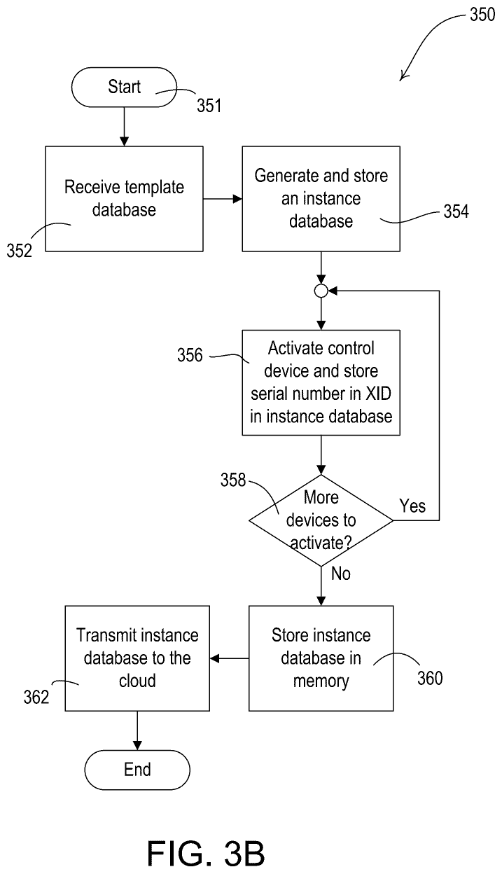

FIG. 3A is a flowchart of an example of a procedure 300 for commissioning and configuring areas of load control system using a template database and local instance databases, as described herein. For example, one or more portions of the procedure 300 may be performed by one or more computing devices, such as a user device and/or one or more remote computing devices. One or more portions of the procedure 300 may be stored in memory as computer-readable or machine-readable instructions that may be executed by a processor of the one or more computing devices. Though portions of the process 300 may be described herein as being performed by a particular computing device, the process 300 may be performed by another computing device or distributed across multiple computing devices, such as one or more user devices, one or more remote computing devices, and/or one or more other devices.

As shown in FIG. 3A, the procedure 300, or portions thereof may be implemented to configure the load control system, or portions thereof, from a template database. The procedure 300 may start at 301. At 302, the one or more computing devices may create a template database. For example, the template database may be created at one or more remote computing devices (e.g., remote cloud servers) in response to a user input received from a user device triggering the generation of the template database. A name or other identifier may be selected for the template database. The name may identify an area type for the template database. At 304, the one or more computing devices may add one or more control devices of the load control system to the template database along with programming information. The one or more control devices and/or the programming information may be included in the programming information stored in the template database. The one or more control devices may include one or more device types for the corresponding area type. In one example, the device types to be included in a given area type may be determined during the design of the commercial and/or residential location and/or the control devices to be installed in the load control system at the location. The programming information may include the control settings, scene settings, load control levels, and/or other programming information for enabling configuration and/or control of the control devices installed in the load control system.

At 306, the one or more computing devices may generate a unique template identifier (XID) for each device name identified in the template database. Each device name in the template database may have a corresponding template identifier. At 308, the one or more computing devices may store the template database in the one or more remote computing devices (e.g., in the cloud) for being accessed as a remote service (e.g., cloud service). At 310, the one or more computing devices may transmit the template database, and/or information stored therein, to a local processor device. For example, the template database, or one or more portions of the programming information stored therein, may be sent to the local processor device in response to a request from the local processor device or the user device that is accessing the local processor device for performing configuration. The template database, or one or more portions of the programming information stored therein, may be transmitted to the local processor device (e.g., in response to the remote computing device receiving an indication that the local processor device has been powered on and/or in response to a request from the local processor device or the user device that is accessing the local processor device for performing configuration). In response to receiving the template database, or one or more portions of the programming information stored therein, the local processor device may generate and store an instance database (e.g., corresponding to the template database for that particular local processor device). If there are more areas to configure (e.g., more local processor devices to which to send template databases) at 312, the one or more computing devices may transmit the template database to another local processor device at 310. When there are not more areas to configure, the procedure 300 may end.

FIG. 3B is a flowchart of an example of a procedure 350 for commissioning and configuring areas of load control system using a template database and local instance databases, as described herein. For example, one or more portions of the procedure 350 may be performed by one or more computing devices, such as a local processor device. One or more portions of the procedure 350 may be stored in memory as computer-readable or machine-readable instructions that may be executed by a processor of the one or more computing devices. Though portions of the process 350 may be described herein as being performed by a particular computing device, the process 350 may be performed by another computing device or distributed across multiple computing devices, such as one or more local processor devices and/or one or more other devices.

As shown in FIG. 3B, the procedure 350, or portions thereof may be implemented to configure the load control system, or portions thereof, from a template database. The procedure 350 may start at 351. At 352, the local processor device may receive a template database (e.g., from a user device and/or one or more remote computing devices as transmitted at 310 of the procedure 300 shown in FIG. 3A). At 354, the local processor device may generate and store an instance database locally that reflects the number of devices represented in the template database. Each of the local processor devices may receive and/or generate an instance database based on the same template database locally for storing unique identifiers of local devices in the load control system with programming information of template identifiers for programming similar types of devices in a similar area type (e.g., king suite, queen suite, conference room, master bedroom, etc.) using the same template database.

At 356, the local processor device may activate the one of the control devices in the respective areas of the load control system for which they are each being configured for control. For example, each of the local processor devices may be configured for controlling a similar room type (e.g., king suite, queen suite, conference room, master bedroom, etc.) having a similar number and type of control devices. Each of the control devices may be activated in the area by being installed and perform an activation procedure thereon so that the control devices may be recognized in the load control system and by the local processor devices. The activation procedure may include populating or mapping the unique identifier of physical control devices in the room with the corresponding template identifiers in the instance database for enabling communication with the physical control devices in the room for load control in the load control system. Activation may be performed for each area, as different physical devices in each room are activated in the load control system for enabling load control. At 356, the local processor device may store a respective unique identifier for the physical control device in the template identifier (XID) in the local instance database. When there are more control devices to activate at 358, the local processor device may activate another control device at 356.

When there are not more control devices to active at 358, the local processor device may store the local instance database (e.g., including the programming information for each of the unique identifiers of devices in the load control system) in memory at 360. The programming information may enable the local processor devices to communicate with and/or control the control devices in the area using the programming information in the template database. For example, the local instance database may be programmed with the control settings, scene settings, load control levels, and/or other programming information for enabling control of the respective control devices being controlled by each local processor device. At 362, the local processor device may transmit the local instance database to the one or more remote computing devices (e.g., for being backed up in the cloud), before the procedure 350 ends. Backing up the local instance database in the cloud may allow the local instance database to be downloaded to a replacement local processor device at a later time.

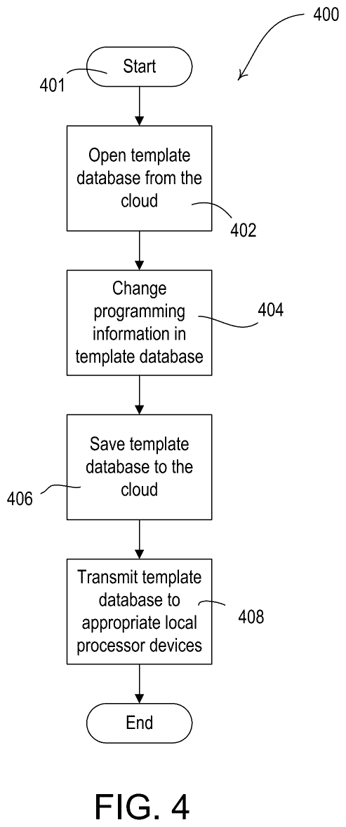

FIG. 4 is a flowchart of an example of a procedure 400 for updating the programming information used to control devices in a load control system, as described herein. For example, the one or more portions of the procedure 400 may be performed by one or more computing devices, such as a user device and/or one or more remote computing devices. One or more portions of the procedure 400 may be stored in memory as computer-readable or machine-readable instructions that may be executed by a processor of the one or more computing devices. Though portions of the procedure 400 may be described herein as being performed by a particular computing device, the procedure 400 may be performed by another computing device or distributed across multiple computing devices, such as one or more user devices, one or more remote computing devices, and/or one or more other devices.

As shown in FIG. 4, the one or more computing devices (e.g., a user device) may open a template database at 402 from the cloud service (e.g., from one or more remote computing devices). The template database may include the programming information (e.g., comprising system configuration data). The programming information in the template database may include control settings, scene settings, load control levels, and/or other programming information. The programming information may include association information for associating devices represented by temporary identifiers in the template database. The one or more computing devices (e.g., the user device) may make changes to the programming information at 404 (e.g., in response to received user inputs). The changes may include changes to the number and/or type of control devices. The one or more computing devices (e.g., the user device) may save the changes to the template database in the cloud (e.g., on the one or more remote computing devices) at 406. The one or more computing devices (e.g., the user device) may transmit the updated template database, and/or one or more updated portions of the programming information therein, to the local processor devices having a corresponding local instance database stored thereon, at 408. This may allow for the updates to be pushed to each of the local processor devices without requiring the one or more computing devices (e.g., the user device) to access each of the local instance databases and update the programing information in each local instance database individually. The updated template database may be transmitted to the local processor device at the same time (e.g., in parallel) and/or in response to requests from the local processor devices or the user device indicating local processor devices to be updated (e.g., on demand).

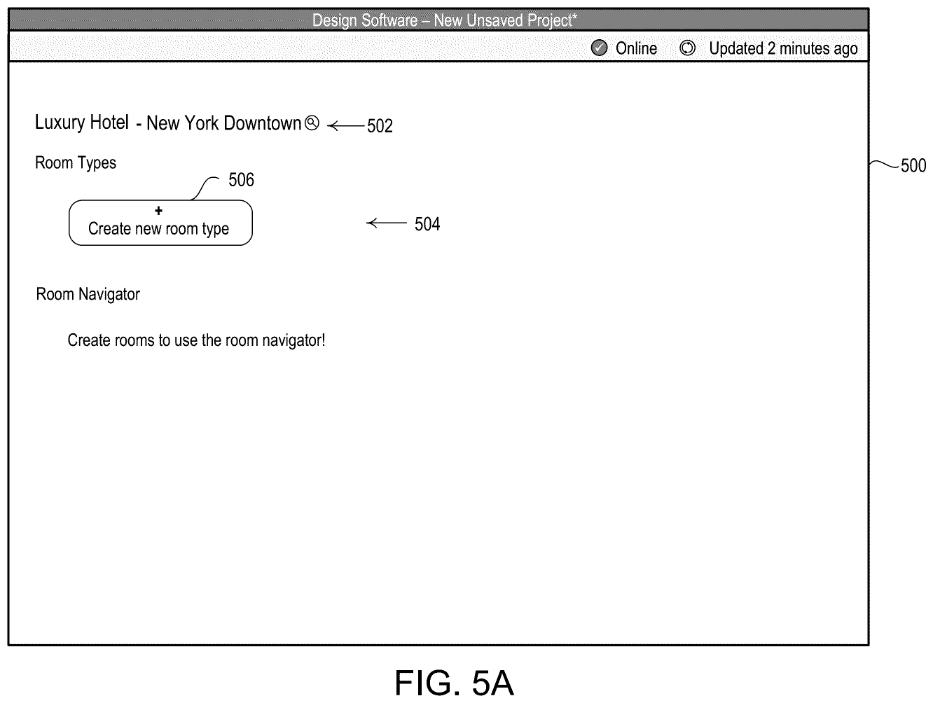

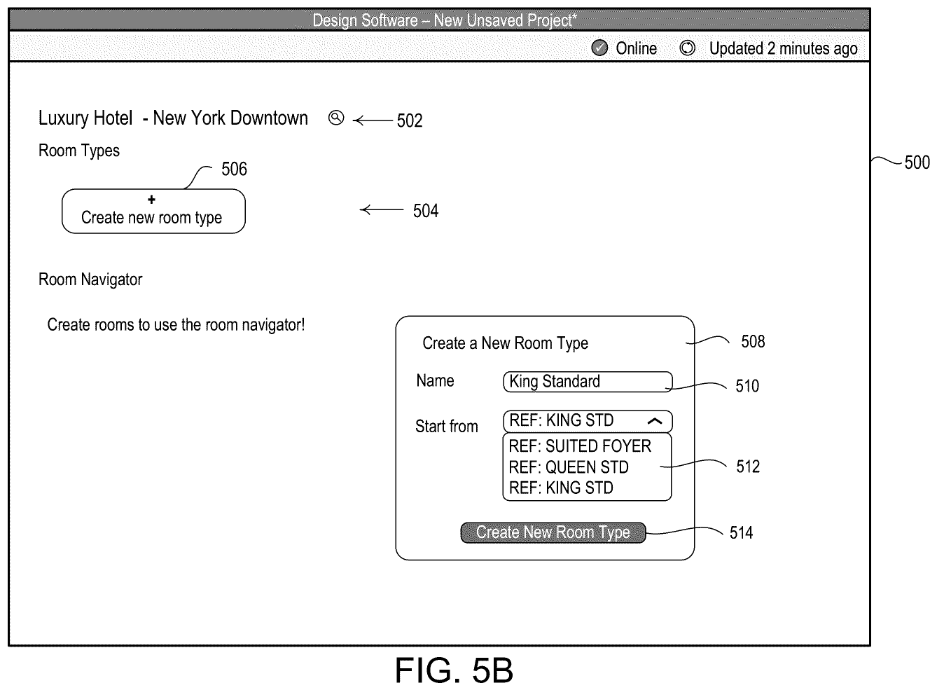

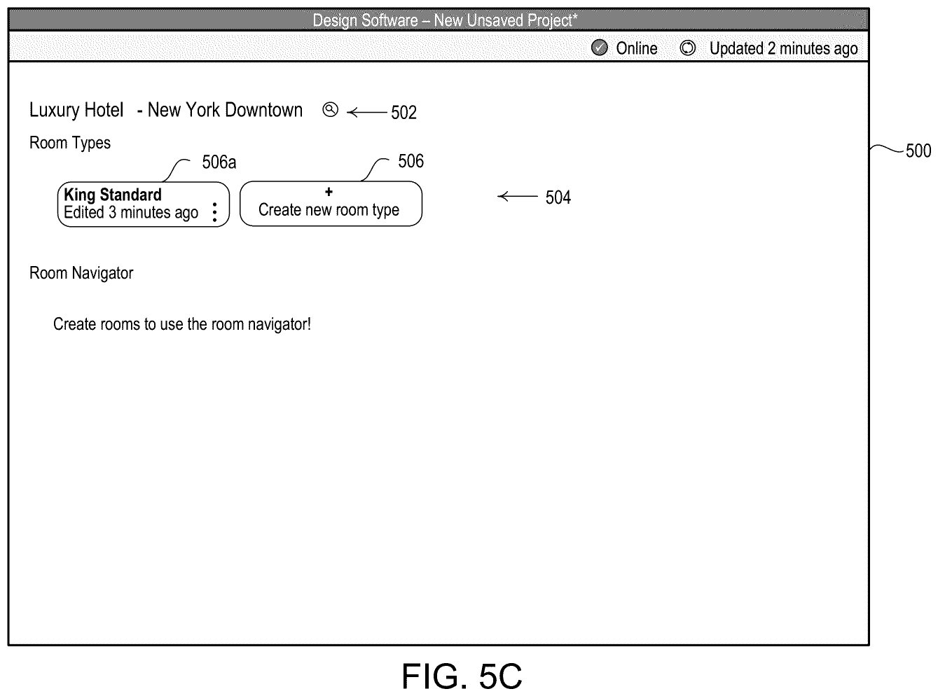

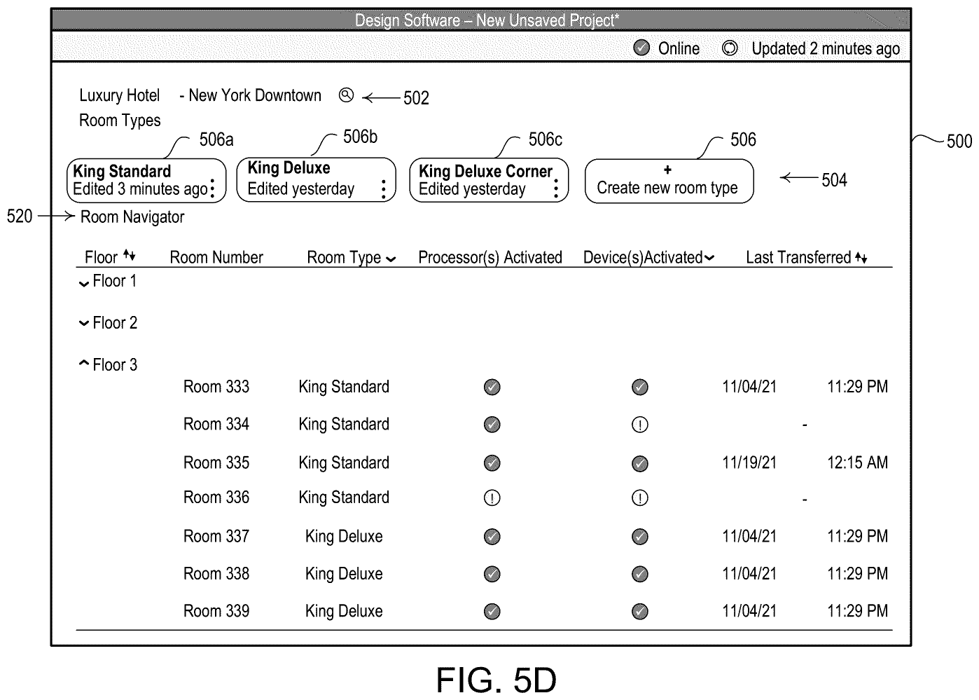

FIGS. 5A-5D depict an example graphical user interface 500 for enabling configuration of different template databases corresponding to area types of a load control system. The graphical user interface 500 may be generated from computer-executable instructions executed locally on a user device and/or executed on a remote computing device and displayed via a local application (e.g., a browser or local application) executed on the user device. The graphical user interface 500 shown in FIGS. 5A-5D may be provided for an area type, such as a room type in a hotel. However, other area types may be similarly configured and/or controlled, as described herein. As shown in FIG. 5A, the graphical user interface 500 may include a button 506 that may be actuated for creating one or more area types 504. For example, the one or more area types may be room types. The one or more area types 504 that are created may be listed on the graphical user interface 500. The graphical user interface 500 may display a building name 502 of a building or other site for which the one or more area types 504 are created.

As shown in FIG. 5B, after receiving an actuation of the button 506, the graphical user interface 500 may display a window 508 for allowing the user to create a template database for one of the one or more area types 504. The area type may be configured with a name 510 or another unique identifier for the template database. The user device may receive a selection of a previously configured template database for the building or that has been previously created for another building from which to begin the configuration. Each template database for a given building may be different. The user device may display a blank template database or display a previously configured template database, which may be selected from a list 512 that includes previously configured programming information for other template databases. The previously configured template databases in the list 512 may each include a number of devices and/or device types. The previously configured template databases in the list 512 may each include programming information (e.g., control settings, scene settings, load control levels, and/or other programming information) previously configured for enabling configuration and/or control of the devices in another template database. The user device may display one of the previously configured template databases in the list 512 and the template databases may be updated in response to user input for being stored as a new template database for one of the one or more area types 504 of the building being configured.

Whether the user device displays a new template database or displays one of the previously configured template databases in the list 512, the user device may receive a selection of a button 514 to create the area type. The user device may add the number of devices and/or type of devices being configured for the area type in response to user input. The user device may receive input that may identify the number of devices and/or type of devices being configured from a design application that has been used to design a given area type in the building 502. For example, the number of devices and/or type of devices being configured may be indicated in a floorplan of a building that includes one or more areas. The user device may generate or receive (e.g., in response to user input) the corresponding programming information (e.g., control settings, scene settings, load control levels, and/or other programming information) for each device or device type in the template database being programmed for the area type 504.

After the user configures the template database, the template database may be stored as a template database that is accessible via a button 506a, as shown in FIG. 5C. The user device may access the template database in response to actuation of the button 506a for editing the programming information stored in the template database. The user device may select (e.g., in response to user input) the button 506 to create another template database for another area type of the one or more area types 504.

As shown in FIG. 5D, the graphical user interface 500 may include an area navigator 520 that includes information about each of the areas configured in the load control system. The area navigator 520 may include the areas (e.g., Rooms 333-339 on Floor 3) that have been configured and/or that are being configured for the building 502. Each area may have a local processor device. The areas may correspond to different subsystems in the load control system. The area navigator 520 may include an area type (e.g., King Standard, King Deluxe, King Deluxe Corner) that corresponds to each area. The area type may correspond to the name of one or more template databases 506a, 506b, 506c that have been created.

The area navigator 520 in the graphical user interface 500 may indicate whether the local processor device for the area has been activated. For example, the “processor[s] activated” column may be checked as green if the local processor device in this room is activated. The local processor device may be activated when the local processor device identifies an area type and/or identifier of an area (e.g., Room 333, etc.) in which the local processor device is installed. The local processor device may be activated by pressing a button on the local processor device and/or discovering the local processor device by a user device. The user device may then select (e.g., in response to user input) an area type and/or identifier of an area in which the local processor device is installed. The local processor device may be activated before the local instance database for the area is created and/or the template database is stored locally. The local processor device may be activated for the area by storing a unique identifier of the local processor device with an area identifier. Each of the control devices in the area may be activated by having their unique identifiers discovered by the local processor device for the area and the local processor device entering the unique identifiers into the template identifier in the local instance database and/or programming the devices in the area with the programming information from the corresponding template database. Multiple user devices may be working on the areas in the building in parallel to program the local processor devices and may be informed of the processors that have been activated and/or that are not activated.

The graphical user interface 500 may indicate whether the control devices in the area have been activated. For example, the “devices activated” column may be checked as green if the control devices have each been activated for the area. Each of the control devices may be activated in the area by being installed and performing an activation procedure thereon so that the control devices may be recognized in the system and by the local processor devices. The activation procedure may include associating unique identifiers to the physical devices installed in the room or other area for enabling communication with the physical control devices in the room for enabling load control in the load control system. Activation may be performed for each area, as different physical control devices in each room are activated in the load control system for enabling load control.

The graphical user interface 500 may indicate a time at which programming information stored in a template database was last transferred to a local processor device for an area. The time at which the programming information was last transferred may be indicated by the “last transferred” column. The time of the last transfer may be indicated by a date and/or time of the last transfer. The user may change the programming information in a given template database, as described herein. After changing the programming information in a template database, the updated programming information may be transferred to the local processor device. The programming information may be transferred after the local processor device and the corresponding control devices for the area have been activated. The graphical user interface may also, or alternatively, indicate when a local instance database created at a local processor device has been backed up to a remote computing device.

The user may perform updates to areas having the same area type by changing the programming information in the template database that is used for programming each of the areas. The update may be performed once and each of the areas having the same area type may be updated by transferring the updated template database, or one or more portions of the programming information stored therein, to the local processor devices for receiving the updates. For example, if the user updates the template database for the “King Standard” template database 506a, the updates may be transferred to the local processor device for Room 333, Room 334, Room 335, and Room 336, as the update may apply to each area having the “King Standard” area type. The updated programming information may apply to Rooms 333, 334, 335, and 336 without changing the room specific information for each room. The remote computing device may store different versions of a template database for being accessed later in time and/or for tracking the versions that have been transferred to each local processor device.

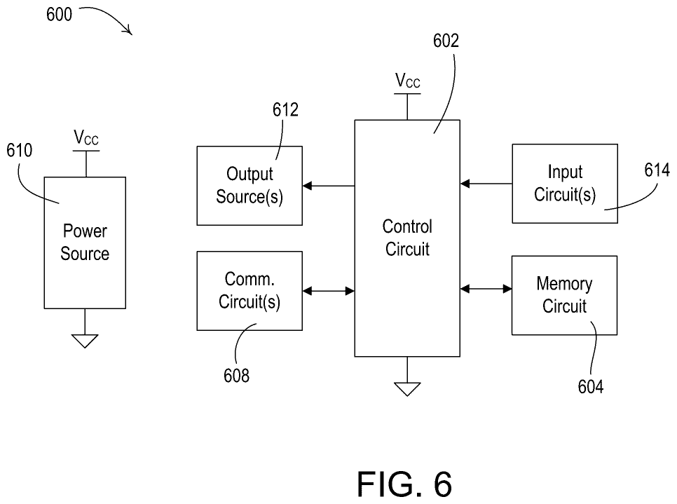

FIG. 6 is a block diagram illustrating an example computing device 600. For example, the computing device 600 may be a user device (such as the user device 128), a local hub device (such as the local processor device 162), a remote server device (such as the remote server device operating the remote services 164), an input device (such as the remote control device 116, the sensor devices 112, 150, and/or the access point 137), and/or another computing device as described herein. The computing device 600 may include a control circuit 602 for controlling the functionality of the computing device 600. The control circuit 602 may include one or more general purpose processors, special purpose processors, conventional processors, digital signal processors (DSPs), microprocessors, integrated circuits, a programmable logic device (PLD), application specific integrated circuits (ASICs), or the like. The control circuit 602 may perform signal coding, data processing, image processing, power control, input/output processing, or any other functionality that enables the computing device 600 to perform as one of the input devices of the load control system (e.g., the load control system 100) described herein.

The control circuit 602 may be communicatively coupled to a memory 604 to store information in and/or retrieve information from the memory 604. The memory 604 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory. The memory 604 may be implemented as an external integrated circuit (IC) or as an internal circuit of the control circuit 602. The memory 604 may include computer-readable or machine-readable instructions configured to be executed by the control circuit 602 to perform as described herein. For example, the memory 604 may comprise computer-executable instructions or machine-readable instructions that when executed by the control circuit configure the control circuit to provide one or more portions of the procedures described herein. The control circuit 602 may access the instructions from the memory 604 for being executed to cause the control circuit 602 to operate as described herein, or to operate one or more other devices as described herein. The memory 604 may comprise computer-executable instructions for executing configuration software. For example, the control circuit 602 may be configured to store in and retrieve from the memory 604 configuration data for configuring the load control devices of the load control system and/or control data for controlling the load control devices of the load control system.

The computing device 600 may include one or more communication circuits 608 that are in communication with the control circuit 602 for sending and/or receiving messages (e.g., digital messages) including information as described herein. The communication circuit 608 may be implemented as an external integrated circuit (IC) or as an internal circuit of the control circuit 602. The communication circuit 608 may perform wireless and/or wired communications. The communication circuit 608 may be a wired communication circuit configured to communicate on a wired communication link. The wired communication link may include an Ethernet communication link, an RS-485 serial communication link, a 0-10 volt analog link, a Digital Addressable Lighting Interface (DALI) digital communication link, and/or another wired communication link. The communication circuit 608 may be configured to communicate via power lines (e.g., the power lines from which the input device 600 receives power) using a power line carrier (PLC) communication technique. The communication circuit 608 may be a wireless communication circuit including one or more RF transmitters, receivers, transceivers, or other communication circuit configured to perform wireless communications.

Though a single communication circuit 608 may be illustrated, multiple communication circuits may be implemented in the computing device 600. The computing device 600 may include a communication circuit configured to communicate via one or more wired and/or wireless communication protocols and at least one other communication circuit configured to communicate via one or more other wired and/or wireless communication protocols. For example, a first communication circuit may be configured to communicate via a wired or wireless communication link, while another communication circuit may be configured to communicate on another wired or wireless communication link. The first communication circuit may be configured to communicate via a first wireless communication protocol on a network communication link and the second communication circuit may be configured to communicate via a second wireless communication protocol on a short-range communication link or a direct communication link.

The control circuit 602 may be in communication with one or more input circuits 614 from which inputs may be received. The input circuits 614 may be included in a user interface for receiving input from the user. For example, the input circuits 614 may include one or more actuators that may be actuated in response to actuations of one or more respective physical buttons by a user to communicate user input or selections to the control circuit 602. The one or more actuators may be actuated to cause the control circuit 602 to enter an association mode, cause the communication circuit 608 to transmit association messages from the computing device 600, and/or signal other information to the control circuit 602. The one or more actuators may be actuated to cause the control circuit 602 to perform control by transmitting control instructions indicating the actuation on the user interface and/or the control instructions generated in response to the actuation. The input circuits 614 may include a touch sensitive surface, such as a capacitive touch surface, a resistive touch surface an inductive touch surface, a surface acoustic wave (SAW) touch surface, an infrared touch surface, an acoustic pulse touch surface, or another touch sensitive surface that is configured to receive inputs (e.g., touch actuations/inputs), such as point actuations or gestures from a user. The control circuit 602 of the computing device 600 may enter the association mode, transmit an association message, transmit a message including control instructions, or perform other functionality in response to an actuation or input from the user on the touch sensitive surface.

The input circuits 614 may include a sensor circuit (e.g., a sensor). The sensor circuit may be an occupant sensing circuit, a light sensing circuit (e.g., an ambient light sensing circuit, a daylight sensing circuit, and/or a photo-sensing circuit), a temperature sensor circuit, a color temperature sensing circuit, a visible light sensing circuit (e.g., an image recording circuit, such as a camera), or another sensing circuit for receiving an input (e.g., sensing an environmental characteristic in the environment of the computing device 600). The control circuit 602 may receive information from the one or more input circuits 614 and process the information for performing functions as described herein.

The control circuit 602 may be in communication with one or more output sources 612. The output sources 612 may include one or more indicators (e.g., visible indicators, such as LEDs) for providing indications (e.g., feedback) to a user. The output sources 612 may include a display (e.g., a visible display) for providing information (e.g., feedback) to a user. The control circuit 602 may generate a graphical user interface (GUI) via software for being displayed on the display of the output sources 612 of the computing device 600.

Each hardware component within the computing device 600 may be powered by a power source 610. The power source 610 may include an AC power supply or DC power supply, for example. The power source 610 may generate a supply voltage V_{CC} for powering the hardware components within the computing device 600.

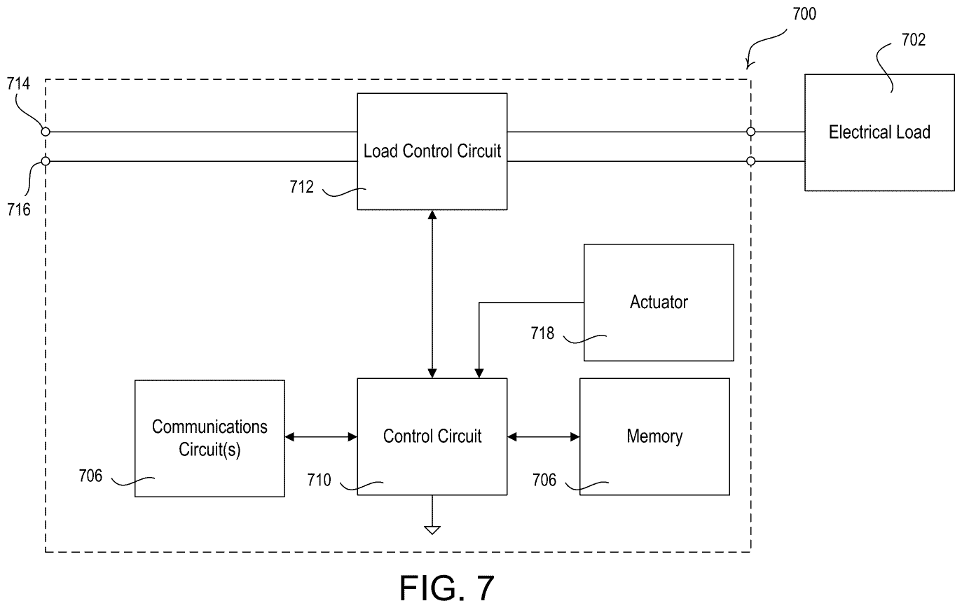

FIG. 7 is a block diagram illustrating an example load control device 700 for controlling an electrical load 702. The load control device 700 may be a lighting control device, such as a dimmer switch, an electronic switch, an electronic ballast for lamps, an LED driver for LED light sources, or another lighting control device (e.g., the lighting control devices 108 shown in FIG. 1). In addition, the electrical load 702 may include any type of electrical load. The load control device 700 may also be, for example, a plug-in load control device for controlling a plugged electrical load (e.g., such as the plug-in load control devices 124 shown in FIG. 1), a controllable electrical receptacle, a temperature control device (e.g., such as the thermostats 136 shown in FIG. 1), a motor drive unit for a motorized window treatment (e.g., such as the motorized window treatments 120 shown in FIG. 1), a motor drive unit for a fan (e.g., ceiling fan), an audio device (e.g., a controllable speaker or playback device), an appliance, a security camera device, or other load control device.

The load control device 700 may include a control circuit 710 for controlling the functionality of the load control device 700. The control circuit 710 may include one or more general purpose processors, special purpose processors, conventional processors, digital signal processors (DSPs), microprocessors, integrated circuits, a programmable logic device (PLD), application specific integrated circuits (ASICs), or the like. The control circuit 710 may perform signal coding, data processing, power control, input/output processing, or any other functionality that enables the load control device 700 to perform as one of the load control devices of the load control system (e.g., the load control system 100) described herein.

The load control device 700 may comprise a load control circuit 712 configured to control the electrical load 702. For example, the load control circuit 712 may be electrically coupled in series between a power source (e.g., an AC power source and/or a DC power source) and the electrical load 702 for controlling an amount of power delivered to the electrical load. The load control circuit 712 may receive power via a hot connection 714 and the neutral connection 716 and may provide the amount of power to the electrical load 702. The control circuit 710 may be configured to control the load control circuit 712 for controlling the electrical load 702. The control circuit 710 may receive feedback to from the load control circuit 712 and determine a of the electrical load 716 in response to the feedback from the load control circuit 712.

The control circuit 710 may store information in and/or retrieve information from the memory 706. For example, the memory 706 may maintain a registry of associated control devices and/or control settings/configuration instructions for responding to triggering events or other control instructions. The memory 706 may include a non-removable memory and/or a removable memory. The load control device 700 may include one or more communication circuits 706 that are in communication with the control circuit 710 for sending and/or receiving messages (e.g., digital messages) including information as described herein. The communication circuit 706 may be implemented as an external integrated circuit (IC) or as an internal circuit of the control circuit 710. The communication circuit 706 may perform wireless and/or wired communications. The communication circuit 706 may be a wired communication circuit configured to communicate on a wired communication link. The wired communication link may include an Ethernet communication link, an RS-485 serial communication link, a 0-10 volt analog link, a Digital Addressable Lighting Interface (DALI) digital communication link, and/or another wired communication link. The communication circuit 608 may be a wireless communication circuit including one or more RF transmitters, receivers, transceivers, or other communication circuit configured to perform wireless communications. The control circuit 710 may control the load control circuit 712 for controlling the electrical load 716 based on one or more received instructions, which may be stored in memory 706 and/or received via the communication circuit 706.

Though a single communication circuit 706 may be illustrated, multiple communication circuits may be implemented in the load control device 700. The load control device 700 may include a communication circuit configured to communicate via one or more wired and/or wireless communication protocols and at least one other communication circuit configured to communicate via one or more other wired and/or wireless communication protocols. For example, a first communication circuit may be configured to communicate via a wired or wireless communication link, while another communication circuit may be configured to communicate on another wired or wireless communication link. The first communication circuit may be configured to communicate via a first wireless communication protocol on a network communication link and the second communication circuit may be configured to communicate via a second wireless communication protocol on a short-range communication link or a direct communication link.

The control circuit 704 may be in communication with an actuator 718 (e.g., one or more buttons) that may be actuated by a user to communicate user selections to the control circuit 704. For example, the actuator 718 may be actuated to put the control circuit 704 in an association mode and/or communicate association messages from the load control device 700.

Although features and elements are described herein in particular combinations, each feature or element can be used alone or in any combination with the other features and elements. The methods described herein may be implemented in a computer program, software, instructions, or firmware stored on one or more non-transitory computer-readable media or other machine-readable media for execution by a computer or machine, or portion thereof. For example, the computer-readable or machine-readable media may be executed by a control circuit, such as a processor. Examples of computer-readable media or machine-readable media include electronic signals (transmitted over wired or wireless connections) and computer-readable storage media. Examples of computer-readable storage media include, but are not limited to, a read only memory (ROM), a random access memory (RAM), removable disks, and optical media such as CD-ROM disks, and digital versatile disks (DVDs). The control circuit may access the computer program, software, instructions, or firmware stored on the computer-readable media or machine-readable media for being executed to cause the control circuit to operate as described herein, or to operate one or more devices as described herein.

1. A method comprising:
receiving, at a local processor device, a template database configured for an area type in a load control system, wherein the template database comprises a plurality of template identifiers labeled with corresponding device names for devices identified for the area type, and wherein the template database comprises programming information for the template identifiers that is configured to control at least one load control device to be installed in the load control system;
creating a local instance database at a local processor device that corresponds to the template database configured for the area type, wherein the local instance database comprises the plurality of template identifiers and the programming information;
populating the template identifiers of the local instance database with unique identifiers of physical devices in a subsystem of the load control system, wherein the unique identifiers comprise a unique identifier of at least one input device and at least one load control device installed in the subsystem, wherein the populating of the unique identifiers of the physical devices defines how the at least one load control device installed in the subsystem is controlled in response to the at least one input device installed in the subsystem; and
controlling the at least one load control device in the subsystem according to the programming information and based on the unique identifiers of the physical devices that are stored in the template identifiers of the local instance database.

2. The method of claim 1, wherein the programming information comprises at least one of control settings, scene settings, or load control levels.

3. The method of claim 1, further comprising:
determining a portion of the programming information identified by the template identifier corresponding to the unique identifier of at least one of the physical devices in the subsystem; and
transmitting the portion of the programming information to the at least one physical device in the subsystem.

4. The method of claim 1, wherein the template database comprises a first template database, the method further comprising:
receiving a second template database for the area type in the load control system, wherein the second template database comprises the plurality of template identifiers and updated programming information for the template identifiers; and
updating the local instance database based on the second template database to update the programming information for the physical devices in the subsystem having unique identifiers with corresponding template identifiers having updated programming information.

5. The method of claim 1, wherein the template database comprises association information that comprises associations between template identifiers in the template database, and wherein association of the at least one input device with the at least one load control device is performed upon populating the unique identifiers of the at least one input device and the at least one load control device.

6. The method of claim 1, wherein the programming information comprises at least one triggering event for controlling the at least one load control device, wherein the at least one triggering event comprises at least one timer event or an input received by the at least one input device.

7. The method of claim 1, wherein the input received by the at least one input device comprises at least one preset for a scene, an occupancy or vacancy condition, or a daylight level received by the at least one input device.

8. The method of claim 1, wherein the programming information comprises at least one intensity level or color for controlling output of a lighting load, a position for controlling a motorized window treatment, or a temperature level for controlling a thermostat.

9. The method of claim 1, further comprising:
receiving, at the local processor device, discovery messages from the at least one input device and the at least one load control device that include the unique identifiers of the at least one input device and the at least one load control device in the subsystem of the load control system; and
storing the unique identifiers in memory.

10. The method of claim 9, further comprising:
transmitting, in response to a triggering event, a triggering message configured to trigger the discovery messages, wherein the discovery messages are received in response to the triggering message.

11. A method comprising:
creating a template database for an area type in a load control system, wherein the template database comprises a plurality of template identifiers and corresponding device names for devices identified for the area type;
generating programming information for the template database, wherein the programming information is generated for each of the template identifiers that is configured to control at least one load control device to be installed in the load control system; and
transmitting the template database to each of a plurality of local processor devices in the load control system, wherein each local processor device is configured to manage a subsystem of the load control system.

12. The method of claim 11, wherein each template identifier in the template database is defined for a device type.

13. The method of claim 11, wherein the template identifiers in the template database are each configured to be populated with a unique identifier of a corresponding physical device installed in the subsystem for enabling the control of the at least one load control device.

14. The method of claim 11, wherein the programming information defines how the at least one load control device to be installed in the subsystem is controlled in response to at least one input device to be installed in the subsystem.

15. The method of claim 11, wherein the programming information comprises at least one preset for a scene, at least one intensity level or color for controlling output of a lighting load, a position for controlling a motorized window treatment, or a temperature level for controlling a thermostat.

16. The method of claim 11, wherein the at least one of the template database is transmitted to each of a plurality of local processor devices in response to a request from each local processor device or a user device.

17. The method of claim 11, wherein the template database comprises a first template database, the method further comprising:
receiving an update to the programming information stored in the template database;
identify the template identifiers corresponding to the updated programming information;
updating the programming information for the corresponding template identifiers; and
transmitting a second template database comprising the updated programming information for the corresponding template identifiers to each of a plurality of local processor devices in the load control system to which the first template database was previously transmitted.

18. The method of claim 7, wherein the second database is transmitted to each of the plurality of the local processor devices in parallel.
